(19) United States
(12) Patent Application Publication
(10) Pub. No.: US 2005/0193653 A1
(43) Pub. Date: Sep. 8, 2005

(54) Door jamb assemblies and door assemblies

(75) Inventor: Brent J. Cornell, Green Bay, WI (US)

Correspondence Address: WILHELM LAW SERVICE, S.C., 100 W LAWRENCE ST, THIRD FLOOR, APPLETON, WI, 54911, US

(73) Assignee: Bay Industries, Inc, Green Bay, WI (US)

(21) Appl. No.: 11/103,419

(22) Filed: Apr. 11, 2005

Related U.S. Application Data
(63) Continuation-in-part of application No. 10/785,241, filed on Feb. 24, 2004.

(51) Int. Cl. E06B 1/04

(52) U.S. Cl. 52/204.1

(57) ABSTRACT

Door jamb assemblies, and corresponding door assemblies, having anchors received in cavities in corresponding jambs of the door assemblies. Structure and positioning of the anchors acts to add stiffness, rigidity to the jamb assembly, as well as to facilitate mounting the door jamb assembly in a rough opening in a building. The jamb assembly is readily attached to a framing member of a building such that the jamb assembly moves in unison with movement of the building. When the door assembly is mounted using fasteners of the invention, further manipulation of the head of the fastener is ineffective to remove the door assembly from the building.

### BACKGROUND

This invention relates to door jambs, jamb elements, jamb assemblies, and door assemblies, typically used as exterior ports of entry into buildings. The invention relates especially to metal door jambs and metal door assemblies. Metal doors and door assemblies are known for use in buildings wherein the building frame is primarily made of metal. Thus, it is known to use a metal door assembly in a building wherein the frame of the building is made primarily of metal.

In buildings wherein the building frame is made primarily of wood, it is known to use wood doors, or metal-clad doors wherein the door slab is either hollow or is filled with wood, or a wood or other fiber composition product. It is also known to use fiberglass doors, foam-filled and polymer skinned doors, and other commercially available door products. For example, in metal pole buildings, especially non-commercial buildings, the building frame is commonly made of wood. The exterior surface of such building comprises a metal skin mounted to the wood frame. Since the exterior of the building is metal, since weather resistance is desirable, the door slab and the jamb assembly preferably have metal exteriors. In such instances, it is conventionally known to use a metal jamb assembly. However, it is difficult to attach known conventional metal jamb assemblies to the building when using conventionally known door-related products and conventional attachment procedures. In addition, conventional metal jamb assemblies are so structured that the metal jamb can be easily contorted, distorted, and the metal jamb is typically susceptible to forced entry, by prying against, and/or bending, the metal jamb.

FIG. 1 shows a front elevation of a first embodiment of a door assembly 10A as typically shipped from a door supplier to a job site. The door assembly 10A includes a door slab 12 mounted in a door frame 14. The frame 14 includes left 16 and right 18 frame jambs, a frame header jamb 20, and a threshold 22. In FIG. 1, the left frame jamb 16 functions as the strike jamb; and the right frame jamb 18 functions as the hinge jamb. The slab 12 is mounted to the frame 14 by a plurality of hinges 24, at the hinge jamb. The slab connects to the strike jamb by a latch assembly, represented in FIG. 1 by a door knob 26.

Referring now to FIGS. 11 and 12 for illustration only, and referring generically to metal frame buildings, metal C-channels “CC” generally define the doorway rough opening, and girts 210, 220 generally provide the framing structures for the outer walls of the buildings. Thus, in a framed-in doorway opening in a metal framed building, the jambs and blocks are attached to the C-channels, instead of being attached to wood studs as in wood framed buildings. Like in wood frame buildings, the door frame 14 includes left 16 and right 18 frame jambs, a frame header jamb 20, and a threshold 22. However, the jamb members 16, 18, 20 of a metal frame building are attached to C-channels “CC,” 44 (FIG. 3), and header girt 210, respectively.

FIG. 2 shows a cross-section of the left frame jamb 16 in a conventional jamb assembly, taken at 2-2 of FIG. 1. Other than adaptation for hinges rather than for the strike, the hinge jamb, in the embodiments discussed herein, typically can be structurally the same as the strike jamb.

As illustrated in FIG. 2, jamb 16 includes an inner flange 28 which is disposed inwardly in a building when the door assembly is installed in the building. Jamb 16 further includes an outer flange 30 which is disposed outwardly of the building when the door assembly is installed in the building. Inner and outer flanges 28, 30 are connected to each other by a jamb face plate 32 which runs generally perpendicular to flanges 28, 30. Jamb face plate 32 has an exterior rabbet section 34, an interior rabbet section 36, and a door stop 38 between the exterior and interior rabbet sections. Rabbet sections 34, 36, and door stop 38 run generally perpendicular to flanges 28, 30. Flanges 28, 30 each include an in-turned flange end 40 which defines an empty space 42 between the distal end 43 of the respective in-turned flange end, and the main body of the respective flange 28 or 30. In some embodiments of jamb 16, 18, distal ends 43 of flanges 28, 30 are omitted.

A first conventional (not the invention) out-swing door frame assembly, ready to be installed in a metal frame building, is illustrated in cross-section in FIG. 3. As seen in FIG. 3, an open-sided C-channel 44 is mounted to e.g. a jamb 16, e.g. to the jamb illustrated in FIGS. 1 and 2, at in-turned flange ends 40, using screws 46. Typically, the C-channel and jamb are shipped generally attached to each other, e.g. similar to the attachment of the C-channel and jamb illustrated in cross-section in FIG. 3.

Alternatively, the C-channel and jamb can shipped separately to the construction site, and are assembled to each other at the construction site to form the jamb assembly shown in FIG. 3. After the jamb and C-channel are so assembled, off-site or at the construction site, the open side of the C-channel receives a bottom anchor which secures the C-channel into the e.g. concrete floor (not shown) and a top anchor which secures the C-channel into a top girt through apertures 50. Flange 48 of the C-channel is then used for attaching the exterior metal panel 51 to the building using fasteners 52.

A second conventional door frame assembly, used for mounting an in-swing steel door frame into an opening in a wood frame building, is shown in cross-section in FIG. 4. As shown in FIG. 4, typically in a wood frame building construction, the door rough opening, into which the door frame assembly is to be placed, is framed with a double stud structure employing first 54 and second 56 studs.

In the FIG. 4 structure, a sheet metal connecting bracket 58, known in the art as a “universal stud anchor”, includes a mounting plate 60, bracket retainers 61, and legs 62. Mounting plate 60 is received inside the inner space 59 which is defined inside the jamb 16, 18, e.g. between inner and outer flanges 28, 30, thus to define the jamb assembly. As used herein, inner space 59 includes the earlier-mentioned empty space 42 which is located between the distal end 43 of the in-turned flange end and the main body of the respective flange 28 or 30.

A major face of a typical such universal stud anchor bracket 58 is shown, at mounting plate 60, as generally spanning the primary cross-section of inner space 59 in FIG. 4, transverse to, and generally perpendicular to, the length of the respective jamb. First and second bracket retainers 61 extend from mounting plate 60 into empty spaces 42 to assist in holding bracket 58 in place relative to the jamb, e.g. jamb 16 or jamb 18. First and second legs 62 of bracket 58 extend from mounting plate 60 and are twisted and bent, typically at the job site, to fit the contours of stud 54, whereby the ends of legs 62 lie parallel to the surfaces of stud 54, for securement to the stud. Legs 62 are typically twisted 90 degrees from the plane of mounting plate 60, and are bent to follow the surfaces of building stud 54. Screws 64, e.g. wood screws, are installed through legs 62 and into stud 54, thereby to secure legs 62 to stud 54, and correspondingly to secure bracket 58, and thus the jamb assembly, to stud 54, namely to the building.

A plurality of such brackets 58 are mounted in each of the left and right jambs, and optionally the header jamb, sufficient in number to anchor the door frame assembly in the rough opening. Typically, between four and six such brackets are used at each of jamb 16 and jamb 18 for a nominally 80 inch high door rough opening. Contrary to the prior art embodiment of FIG. 3, this prior art embodiment can be assembled as a door assembly, typically less stud anchors 58, prior to being mounted in the doorway rough opening.

Such door assembly is mounted in a building rough opening by first inserting the brackets 58 in the open sides of the jambs at spaced locations along the lengths of the respective jambs. Brackets 58 are used in both left and right jambs 16, 18, and are optional in header jamb 20. Prior to inserting the door assembly into the rough opening, legs 62 are twisted about 90 degrees and, on e.g. the inner side of the door assembly, are bent so as to clear the rough opening. As used here, inner means relative to the interior of the building. Then, the door assembly is inserted/tipped into the rough opening, and legs 62 are bent to conform to the surfaces of the corresponding frame members, such as studs 54.

Shims are inserted between the door jamb assembly and the building members, to properly align and square the door relative to the building frame. But the shims can only be inserted in proximity to the respective brackets 58. Shims can be used only at these locations because there is nothing inside the throat of the jamb against which to wedge the ships to effectively hold the frame in place. Legs 62 are then secured to the studs, thus securing the door assembly to the building framing members as shimmed, at the rough opening. Of course, once the frame is in place in the rough opening, any of the legs can be attached to e.g. stud 54 before any other, or all, of the legs are bent to conform to the surfaces of the respective building framing members.

While brackets 58 successfully mount the door assembly to the building, the design of brackets 58 leaves an undesirable level of potential movement of the door frame relative to the building, after attachment of the door assembly to the building. For example, legs 62 must be fabricated from metal sufficiently soft as to be twisted about 90 degrees, and to be bent to fit against stud 54 or other building framing members, at the construction site. Plate 60, which is friction fit into the inner space 59 inside the flange, is typically made of the same relatively softer metal as legs 62, thereby to accommodate the bending of the legs. Indeed, bracket 58 is known as a unitary piece of flat sheet metal product. Such requirement for bending thus operates as a limiting factor to limit the degree of rigidity of flange 58, thereby limiting the rigidity which can be achieved with mounting plate 60. Thus, however carefully the workers fit and install the door assembly, brackets 58 inherently exhibit an undesirable degree of flex capacity between plates 58 and the points where screws 64 attach the legs to the building at studs 54. It is that flex capacity which defines the inherent capability of the door assembly to move relative to the building after the door assembly is mounted in the building.

Brackets 58 are placed at spaced locations in the left and right jambs 16, 18. For example, typically 3 to 4 brackets are used in each of the left and right jambs. Brackets 58 are made of thin sheet metal, such as 20 gauge sheet metal, about 0.038 inch thick, and the material must be so selected in order that the bracket legs be sufficiently bendable to accommodate twisting and bending, which enables placement of legs 62 in surface-to-surface relationship with studs 54, thereby facilitating attachment of the legs to the studs, as well as providing for an aesthetically pleasing appearance and thin cross-section of the legs; which facilitates covering fasteners 64 with trim or other finish material.

In light of the above, the vast majority of the length of the inner space 59 defined on the interior of the jamb, e.g. along the length of the jamb, is empty, and thus is not occupied by a bracket 58, nor occupied by any other structure which prevents or limits flexing of the jamb or movement of the jamb relative to the building. Namely, the interior cavity of the jamb, which is located between the inner surfaces of rabbets 34, 36 and stud 54 is largely empty, whereby the jamb has substantial capacity, and freedom, to flex as the door is opened and closed, and as other typically-imposed forces are expressed on the door frame. Such flexing is, of course, also undesirable for purposes of deterring unauthorized entry through the doorway.

In addition, because of the flexing capability of legs 62, such typical forces cause the door frame/jamb assembly, after installation in the building has been completed, to move relative to the building frame. Namely, even though legs 62 are properly anchored to stud 54 by screws 64, even though legs 62 are properly configured relative to stud 54 and flange ends 40, according to normal skills in the building trades, the door frame/jamb assembly can move relative to the building. Such movement is, of course, undesirable in that the overall concept of the building structure is that the respective structural elements of the building, including the door jamb assemblies, reinforce each other, and move together, thereby to fulfill and preserve the structural integrity of the building.

FIG. 5 shows still another prior art structure by which an in-swing metal door assembly is conventionally mounted to a wood frame building at the rough opening. As suggested in FIG. 5, the jamb assembly comprises conventional left and right jambs, which are anchored to the building framing members using about 10 to 20 standard screws through holes in rabbets 34, 36. Longer e.g. mounting screws 66 are driven through holes in door stop 38, across inner space 59, and into stud 54. Such mounting includes using mounting screws spaced along the length of the jamb, and behind door slab 12, e.g. in interior rabbet section 36.

The embodiment of FIG. 5, like that of FIG. 4, is subject to flexing, dimpling, and/or other distortion of the jamb at rabbets 34, 36, and door stop 38, because of the expanse of the inner space 59 between the contact points of the fasteners at locations 34, 36, and 38, and at stud 54. Relatively smaller and thinner common mounting screws are used due to the relatively larger quantity of screws needed to anchor the jamb 16, 18 which again makes shimming of the jamb assembly difficult because of the lack of structure in inner space 59. The use of the relatively smaller and thinner common mounting screws in the prior art commonly results in bending or breaking of such screws. Jamb 16 can, of course, be made of thicker metal, to attenuate such flexing, dimpling, or other distortion, but at undesirable, unacceptable, incremental cost, whereby such solution is not acceptable.

Thus, it would be desirable to provide jamb assemblies and door assemblies which are easily installed/mounted in buildings, typically preferably as pre-assembled door assemblies, and which are so rigidly mounted in the buildings as to not generally move relative to the buildings to which they are mounted/installed.

### SUMMARY

The invention provides door jamb assemblies, and corresponding door assemblies. Such door assembly includes e.g. a left jamb assembly, a right jamb assembly, a header jamb, and a door slab. The left and right jamb assemblies have spacer blocks and/or anchors received in cavities in the corresponding jambs. The structure and positioning of the respective spacer blocks and/or anchors in the jamb acts to add stiffness and rigidity to the jamb assembly, and provides an interface for effectively securing the jamb assembly to the building frame at the doorway rough opening. The jamb assembly, as part of a door assembly, can readily be so intimately attached to a framing member of a building, whether wood frame building or metal frame building, that the jamb assembly moves in unison with movement of the building framing member. Preferably, both the hinge jamb assembly and the strike jamb assembly are so structured that the door assembly, as a unit, moves in unison with the building members to which they are mounted. The jamb assemblies of the invention provide an efficient interface which readily anchors a metal frame to wood framing members and/or to metal framing members of a building. Jamb assemblies of the invention provide for quick installation, while the spacing blocks and/or anchors collectively provide a generally flat surface as basis for efficient adjustment of the door in a plumb, level orientation, and efficient shimming of the door assembly in the rough opening.

In a first family of embodiments, the invention comprehends a jamb assembly, adapted for use in a door frame, and comprising an elongate jamb and, as a separate and distinct element, at least one anchor, having a length, and being received in the elongate cavity and communicating with the jamb by frictional engagement therewith, thus to enhance at least one of stiffness and rigidity of the jamb assembly. The elongate jamb comprises (i) an inner flange having a first proximal edge, and first inner and first outer surfaces, and a first distal edge, (ii) an outer flange having a second proximal edge, a second distal edge, and second inner and second outer surfaces, and (iii) a jamb face plate, having third inner and third outer surfaces, and extending between the inner flange at the first proximal edge and the outer flange at the second proximal edge, an elongate cavity being generally defined in the elongate jamb by the first, second, and third inner surfaces, and extending along the length of the elongate jamb, and extending from a location at or adjacent an inner surface of the jamb face plate to a location at an elongate opening proximate the first and second distal edges of the inner and outer flanges, the elongate opening being defined along the length of the elongate jamb between the inner and outer flanges.

In some embodiments, the anchor interfaces either directly or indirectly with the elongate jamb at at least three spatially-displaced points on ones of the first, second, and/or third inner surface of the elongate jamb.

In some embodiments, the anchor generally occupies a major portion of the cross-sectional area of the elongate cavity corresponding to the length of the anchor.

In some embodiments, the inner and outer flanges have main flange bodies facing each other, in-turned flange ends, and distal ends of the in-turned flange ends, the distal ends being spaced from the inner surfaces of the main flange bodies, a width of the anchor extending a distance “BW” between the inner and outer flanges, the distance “BW” being greater than a free space width of the elongate opening and less than a distance between the inner surfaces of the main flange bodies of the inner and outer flanges.

In some embodiments, the jamb face plate further comprises a door stop extending outwardly from the remainder of the face plate and defines a door stop void therein, the anchor including an outer wall and a projection extending outwardly from a foundation portion of the outer wall, and wherein, within the scope of the length of the anchor, the projection fills a substantial portion of the door stop void.

In some embodiments, at least first and second anchors are disposed in the elongate cavity.

In some embodiments, the anchors are spaced from each other along the length of the jamb.

In some embodiments, a draw fastener extends through the jamb plate and into one of the anchors, and driving of the draw fastener draws the anchor toward the jamb face plate.

In some embodiments, the jamb assembly further comprises, in the elongate cavity, one or more elements of door interface hardware permanently mounted to the jamb, the door interface hardware extending away from the jamb face plate and toward the elongate opening first distances, the jamb assembly further comprising a draw fastener extending through the jamb plate and into the anchor, and advancing the draw fastener being effective to draw the anchor toward the jamb face plate.

In some embodiments, the anchors extend between the inner flange and the outer flange, and are held in the jamb assembly by frictional engagement with both the inner flange and the outer flange.

In some embodiments, each anchor has a first lateral wall, a second lateral wall, and a base wall which extends generally between the first and second lateral walls, at least one of the first and second lateral walls having a first wall segment and a second wall segment, the first and second wall segments generally intersecting each other and generally defining an obtuse angle therebetween.

In some embodiments, the elongate anchor includes a base wall and an outer wall, the outer wall having at least one foundation portion, and a projection extending outwardly from the foundation portion, the distance between the foundation portion and the base wall generally defining a first height dimension, the distance between the projection and the base wall generally defining a second height dimension, wherein the magnitude of the second height dimension is greater than the magnitude of the first height dimension.

In some embodiments, the anchor comprises a polymeric material.

In some embodiments, the at least one anchor can be mounted in the elongate cavity in combination with a rotating motion of the anchor.

In some embodiments, the anchor has a first lateral wall, a second lateral wall, and a base wall which extends generally between the first and second lateral walls, at least one of the lateral walls and the base wall having a slot extending thereinto, the slot extending along the length of the anchor.

In some embodiments, at least one cavity extends through the anchor, and along the length of the anchor.

In some embodiments, a plurality of anchors are disposed in the elongate cavity, and are spaced at least generally uniformly along the length of the cavity, and impart substantial incremental increase in rigidity to the jamb in the jamb assembly.

In some embodiments, the invention comprehends a door assembly comprising a hinge jamb assembly, a strike jamb assembly, and a header jamb or header jamb assembly, wherein at least one of the hinge jamb assembly and the strike jamb assembly comprise a jamb assembly as of the invention.

The invention further comprehends a building a doorway, and a door assembly in the doorway, wherein the door assembly comprises a door assembly of the invention.

In some embodiments, the door assembly is mounted in the doorway using a fastener having a detachable head, thereby securing the jamb to a anchor, and optionally through the anchor and into a framing member of the building, whereby manipulation of the head is ineffective to remove the fastener from the door assembly.

In a second family of embodiments, the invention comprehends a building doorway, and a door assembly mounted in the doorway. The doorway comprises a rough opening which is defined by building framing members. The door assembly comprises a plurality of elongate jambs, each having a length, and comprising an inner flange having first inner and first outer surfaces, an outer flange having second inner and second outer surfaces, and a jamb face plate having third inner and third outer surfaces, and an elongate cavity therein extending along the length of the elongate jamb, and defined generally between the first and second inner surfaces of the inner and outer flanges, and extending outwardly of the jamb face plate to an elongate opening into the elongate cavity, at least one of the elongate jambs further comprising, as a separate and distinct element, at least one anchor, having a length, and being received in the elongate cavity and, within the scope of the length of the anchor, generally occupying a major portion of the elongate cavity, from the third inner surface of the face plate to the flange ends, the doorway rough opening being defined by at least one structural framing member, in facing relationship with the at least one elongate jamb which comprises the anchor.

In some embodiments, the invention comprehends a building comprising the doorways of the invention.

In some embodiments, a door assembly is mounted in the doorway opening, and the anchor interfaces either directly or indirectly with the elongate jamb at at least three spatially-displaced points on ones of the first, second, and third inner surfaces of the elongate jamb.

In some embodiments, the inner and outer flanges on the at least one elongate jamb, have main flange bodies facing each other, in-turned flange ends, and distal ends of the in-turned flange ends, the distal ends being spaced from the inner surfaces of the main flange bodies, the inner and outer flanges being connected to each other by the jamb face plate, and wherein the width of the anchor extends a distance “BW” between the inner and outer flanges, the distance “BW” being greater than a free span width of the elongate opening and less than a distance between the inner surfaces of the main flange bodies of the inner and outer flanges.

In some embodiments, the inner and outer flanges are connected to the jamb face plate, the at least one anchor comprising at least first and second anchors disposed in the elongate cavity and spaced from each other.

In some embodiments, the inner and outer flanges on the at least one elongate jamb are connected to each other by the jamb face plate, the inner and outer flanges having in-turned flange ends, the jamb assembly further comprising, in the elongate cavity, one or more elements of door interface reinforcing hardware permanently mounted to the jamb, the door interface reinforcing hardware having first thicknesses extending away from the jamb face plate and toward the elongate opening, the anchors collectively providing a mounting surface disposed in a space which extends generally from the door interface hardware outwardly to a locus up to about 0.25 inch beyond the elongate opening.

In some embodiments, the at least one elongate jamb is secured to the building framing members which define the rough opening by at least one fastener, thereby securing the jamb to a anchor, and optionally through the anchor and into a framing member of the building. The fastener comprises a threaded fastener body, and as a separate and distinct element, a fastener head. The fastener body and the fastener head are cooperatively configured such that the head can be mounted on the fastener body and thereafter can be used to drive the fastener body into a anchor, optionally through the jamb assembly and into one of the building framing members which define the rough opening and wherein, after fastener body has been so driven, the fastener head is ineffective to enable removal of the fastener body from the anchor, or from the building framing member, or from the jamb assembly, whereby manipulation of the fastener head is ineffective for releasing the door assembly from the doorway.

In some embodiments, the anchor comprises polymeric material.

In some embodiments, the anchor can be mounted in the elongate cavity in combination with a rotating motion of the anchor.

In some embodiments, the anchor has a first lateral wall, a second lateral wall, and a base wall which extends generally between the first and second lateral walls, at least one of the lateral walls and the base wall having a slot extending thereinto, the slot extending along the length of the anchor.

In some embodiments, a cavity extends through the anchor and along the length of the anchor.

In a third family of embodiments, the invention comprehends a jamb assembly, adapted for use in a door frame, and comprising an elongate jamb having a length, and comprising an inner flange having a first main flange body having a first proximal edge and a first distal edge, an outer flange having a second main flange body having a second proximal edge and a second distal edge, and a jamb face plate extending between the inner flange at the first proximal edge and the outer flange at the second proximal edge, the elongate jamb defining an elongate cavity therein extending along the length of the elongate jamb; and as a separate and distinct element, at least one polymeric anchor, having a length, received in the elongate cavity.

### BRIEF DESCRIPTION OF THE DRAWINGS

FIG. 1 shows a generic front elevation view of a first embodiment of door assemblies of the invention, wherein the depiction in FIG. 1 is generic to both prior art door assemblies, and to door assemblies of the invention.

FIG. 2 shows a cross-section of the door jamb, of the door assembly of FIG. 1, taken at 2-2 of FIG. 1, and illustrating a prior art door jamb.

FIG. 3 shows a cross-section of a portion of a first prior art door frame assembly, not part of the invention.

FIG. 4 shows a cross-section of a portion of a second prior art door frame assembly, not part of the invention.

FIG. 5 shows a cross-section of a portion of a third prior art door frame assembly, not part of the invention.

FIG. 6 shows a cross-section of a portion of a first embodiment of door frame assemblies of the invention, in shipping mode.

FIG. 6A shows a pictorial view of the open side of a hinge jamb assembly, of a door frame assembly of the invention, corresponding generally to the cross-section shown in FIG. 6.

FIG. 6B shows a plan view, partially cut away, of the open side of a hinge jamb assembly, of a door frame assembly of the invention, corresponding generally to the cross-section shown in FIG. 6 and the pictorial view of FIG. 6A.

FIG. 6C shows a pictorial view of the open side of a second embodiment of hinge jamb assemblies, of a door frame assembly of the invention.

FIG. 6D shows a cross-section of a portion of a second embodiment of door frame assemblies of the invention, using the jamb assembly illustrated in FIG. 6C, and mounted to a metal building frame member.

FIG. 6E shows a cross-section of a portion of a third embodiment of door frame assemblies of the invention, using the jamb assembly illustrated in FIG. 6C, and mounted to a wood building frame member.

FIG. 7A shows a pictorial view of a first embodiment of spacing blocks used in metal door frame assemblies of the invention.

FIG. 7B shows a pictorial view of a first embodiment of anchors used in metal door fame assemblies of the invention.

FIG. 7C shows a plan view of the anchor of FIG. 7B.

FIG. 7D shows a plan view of the anchor of FIG. 7B, partially, pivotably, inserted into a portion of a door frame assembly.

FIG. 8 shows a cross-section of a portion of a metal door frame assembly of FIG. 6, installed in a doorway rough opening of a building, and secured to the building.

FIG. 9 is a plan view of an exemplary mounting fastener useful in mounting a door assembly of the invention in a doorway rough opening of a building.

FIG. 10 is an exploded view of the fastener of FIG. 9.

FIG. 11 shows a pictorial view which illustrates door assemblies of FIG. 6D, assembled into a metal-frame building.

FIG. 12 shows a pictorial view of the door assembly of FIG. 11, with the door slab removed.

The invention is not limited in its application to the details of construction or the arrangement of the components set forth in the following description or illustrated in the drawings. The invention is capable of other embodiments or of being practiced or carried out in various other ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

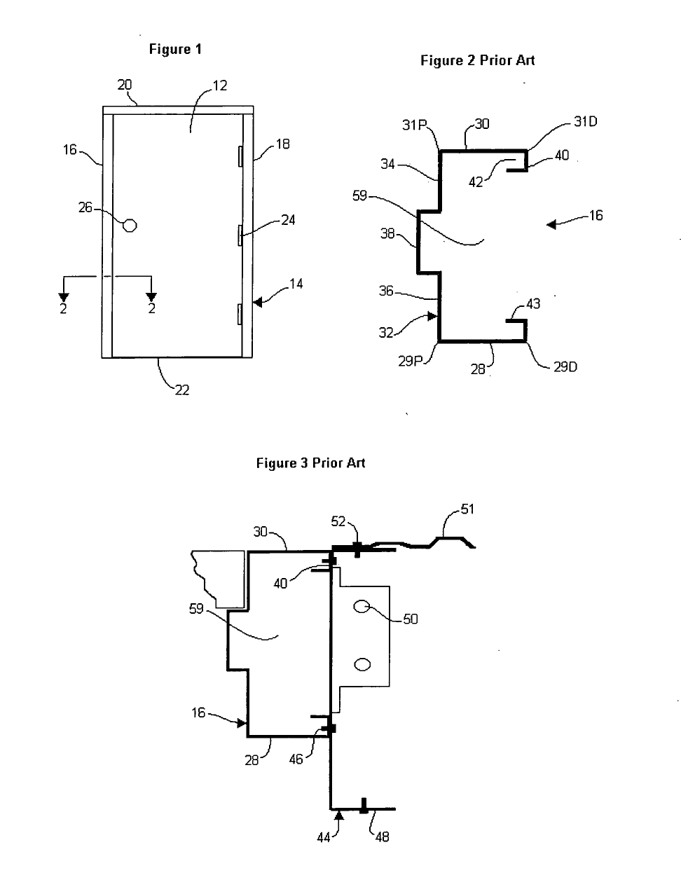

In the invention, the door slab 12 is conventional, and can thus be the same slab illustrated in FIGS. 1, 3, 4, and 5. Accordingly, no further description is given here of the door slab, as any known door slab can be employed, as desired.

The invention is embodied generally in the structure and function of the left and right frame jambs 16 and 18, respectively, as jamb assemblies, optionally also the frame header jamb.

Each such jamb 16 or 18 includes an inner flange 28, an outer flange 30, and a face plate 32. Each of inner and outer flanges 28, 30 has a main flange body 33, and in-turned flange end 40. Each in-turned flange end has a main panel which is generally perpendicular to the respective main body 33, and a distal end which is generally parallel to the main body and spaced from the main body. Each main body has a proximal edge joined to face plate 32, and a distal edge joined to in-turned flange end 40.

In part, the invention is optionally embodied in the cooperation between the jamb assemblies and the framing of the rough opening in the building, and the methods and apparatuses used in mounting the door assembly 10A in the doorway rough opening.

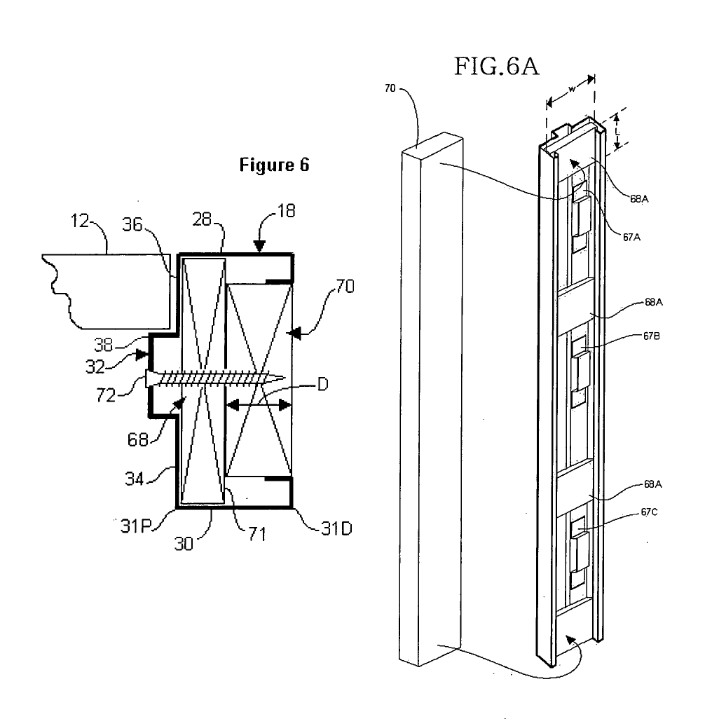

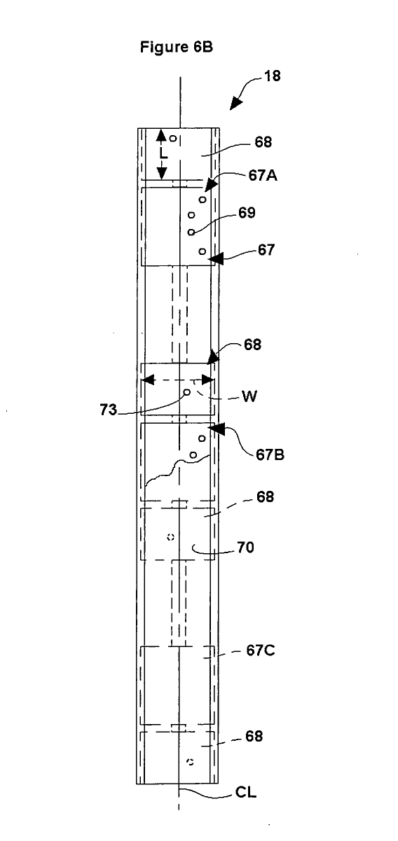

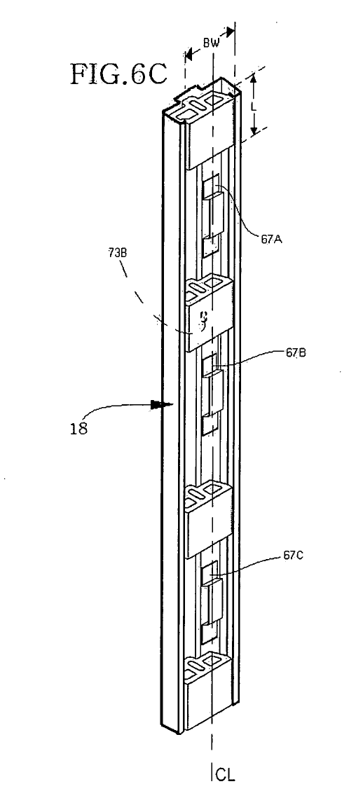

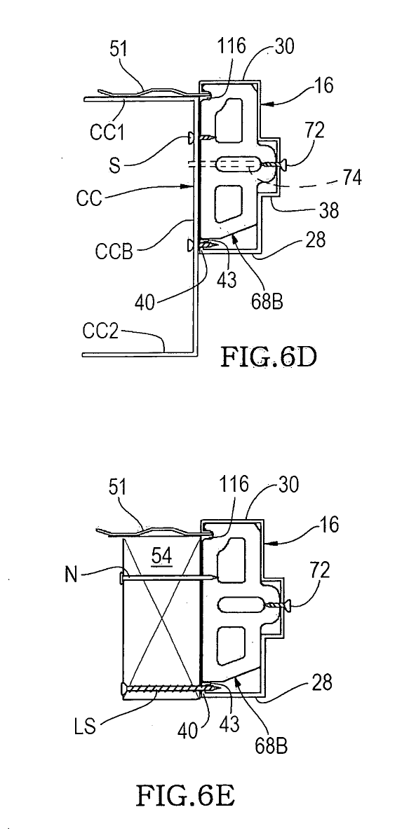

FIGS. 6, 6A, 6B, 6C, 6D, 6E, 7A, 7B, 7C, 7D, 8, 9, and 10, represent specific, exemplary, embodiments of various elements, subassemblies, and assemblies, of the invention. FIGS. 6A and 6C show pictorial views of exemplary embodiments of hinge-side jamb assemblies of the invention, partially cut away, as viewed from the side of the jamb assembly which communicates with a rough opening of a building. As seen in FIGS. 6A, 6B, and 6C, first, second, and third hinge reinforcement plates 67A, 67B, 67C are securely mounted to jamb 18 as by welding, riveting, and/or though other methods of known attachment and/or joinder. Reinforcement plates 67A, 67B, 67C are e.g. 7 gauge steel, about 0.19 inch thick. As shown, the reinforcement plates are mounted to the inside surfaces of rabbet sections 34, 36, and are disposed opposite the mounting loci of hinges 24. Reinforcement plates 67 include drilled and threaded mounting holes 69. Hinges 24 are mounted to hinge jamb 18 by fasteners (not shown) which extend through the respective hinge leaves, and secure to the respective reinforcement plate 67 at the respective holes 69.

Spacing blocks 68A and/or anchors 68B are inserted into, for example, the inner space 59 inside the jamb, and against the inner surfaces of rabbets 34, 36, and bridging across door stop 38. In the embodiments shown, spacing blocks 68A and/or anchors 68B are laterally displaced from plates 67, and are typically generally spaced along the length of jamb 18. Specific locations for blocks 68A and/or anchors 68B are selected as locations which can provide a level, e.g. planar, surface to receive blocks 68A, not overlying plates 67, where the jamb is likely to receive mechanical stress during the use life of door assembly 10. Thus, as illustrated, blocks 68A and/or anchors 68B do not overlie plates 67.

The overall purpose of spacing blocks 68A and/or anchors 68B is to support the steel jamb, e.g. jamb 16 or 18, thus to facilitate the jamb being able to resist mechanical stresses while attenuating or avoiding independent movement of the jamb, independent of corresponding movement of the building into which the jamb, e.g. door assembly, is installed. For example, in embodiments which utilize optional insert 70, spacing blocks 68A provide clearance above plates 67, thus to provide clearance between plates 67 and insert 70, as effected at inner surface 71 of blocks 68A. Further to that end, a fastening aperture is preferably fabricated in door stop 38 opposite each spacing block 68A, whereby a fastener can be driven through the jamb face plate, through the spacing block 68A, and illustratively into insert 70 and a building framing member as described hereinafter.

Spacing blocks 68A and/or anchors 68B can be made of e.g. polymeric materials, such as for example and without limitation, high density polyethylene, polypropylene, polyvinyl acetates, and a variety of remanufactured and/or recycled plastics products of compatible compositions, which are known for use in the construction trades.

An alternative material for e.g. spacing blocks 68A is wood, preferably weather-treated wood, preferably treated with an environmentally friendly treatment such as the now-well known copper solution impregnation. Other materials, without limitation, such as manufactured wood products, e.g. chip board or flake board, can be used instead of, or in combination with, such polymeric materials.

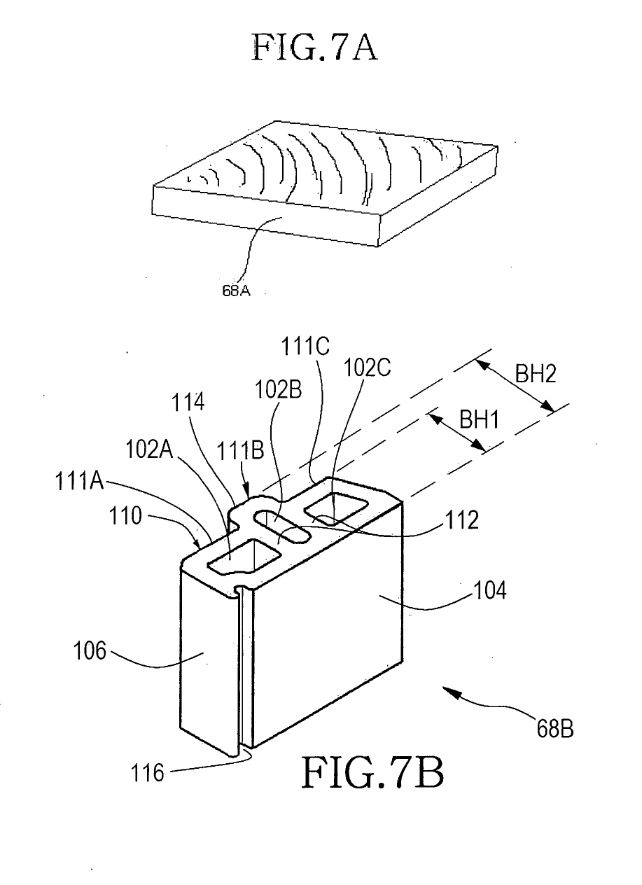

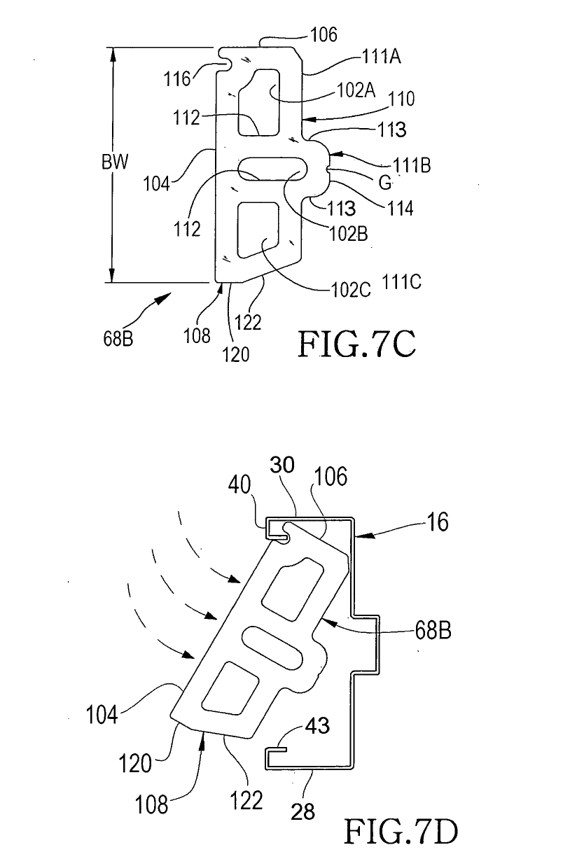

Referring to FIGS. 6A, 6C, and 7C, spacing blocks 68A have width dimensions “W” which generally corresponds with the inner width dimension of inner space 59 between inner 28 and outer 30 flanges of the jamb. Width dimension “BW” corresponds generally with the dimension of inner space 59 between one of flanges 28, 30 and the distal end 43 of the opposing in-turned flange end. Spacing blocks 68A fit somewhat loosely in space 59, between flanges 28 and 30. Anchors 68B preferably have a friction, e.g. wedging, fit between one of flanges 28 and 30, and the opposing distal end 43.

Each of spacing blocks 68A and/or anchors 68B has a length “L” extending along the length of jamb 18. Length “L” is sufficiently great to prevent substantial rotation of the block relative to an axis which is parallel to inner and/or outer flanges 28, 30. In some embodiments, the dimension of length “L” is about the same as the dimension of width “W” or “BW”, such as in the exemplary embodiments of FIGS. 6A and 7A, whereby spacing block 68A is about square.

On the other hand, the dimensions “L,” “W,” and “BW” can vary widely in the invention so long as the spacing block 68A or anchor 68B satisfactorily provides the clearance, performs the spaced blocking function, and provides a consistent reception surface described hereinafter. For example, spacing blocks 68A or anchors 68B can extend the entirety of the length of the jamb, between reinforcement plates 67. However, as shown and for purposes of economy of cost, spacing blocks 68A and/or anchors 68B, are preferably located at selected spaced anchor locations to provide a collectively planar surface to communicate with a door way rough opening and/or to optionally receive insert 70, and to generally enhance especially the bending and/or twisting resistance of the jamb assembly.

Exemplary of economy of cost embodiments, as illustrated in FIGS. 6A, 6C, 7B, and 7C, spacing blocks 68A and/or anchors 68B have width dimensions “W” and “BW” respectively which are each relatively greater in magnitude than the magnitude of the length dimension “L” of the respective spacing blocks 68A and/or anchors 68B. Thus, in some embodiments, spacing blocks 68A and/or anchors 68B are relatively wider than they are long.

Referring now to FIGS. 6C, 6D, 6E, 7B, 7C, and 7D, each of anchors 68B is a generally rigid, preferably an extruded polymeric, member which has an outer surface generally defined, at least in part, by a plurality of walls and/or other structures. Namely, anchor 68B includes base wall 104, first and second sidewalls 106, 108, which are laterally spaced from each other, and outer wall 110. A plurality of cavities, e.g. first, second, and third elongate cavities 102A, 102B, 102C extend axially through anchor 68B.

Base wall 104 extends laterally between first and second wall ends, and has the width “W” spacing between side walls 106 and 108(FIG. 7C).

The generally planar surface of base wall 104 is interrupted by slot 116. Slot 116 extends along the length of anchor 68B, between ends 75 of the spacing block (FIG. 6C) adjacent, or otherwise proximate, at least one of the first and second ends of base wall 104. Slot 116 is adapted and configured to receive e.g. a portion of metal panel 51 therein (FIGS. 6D, 6E) which may comprise e.g. a building siding panel. Thus, in pictorial view, as in FIG. 6C, base wall 104 extends in a generally planar path which is interrupted by slot 116. Although slot 116 is illustrated as U-shaped, slot 116 comprehends a wide variety of other profile configurations suitable to receive and house a portion of metal panel 51. Such other suitable profile configurations include, but are not limited to, V-shaped profiles, squared-U-shaped profiles, and/or others.

Sidewall 106 is generally planar and extends along the length of, and at least partially defines, the length “L” of anchor 68B. Sidewall 106 extends at generally perpendicular angles between base wall 104 and outer wall 110. Accordingly, the magnitude of the width of sidewall 106 corresponds generally to magnitude of the distance between base wall 104 and outer wall 110 e.g. height BH1 (FIG. 7B). As in the exemplary embodiment of FIG. 7C, a generally planar transition, also known as a chamfer, can angularly extend between sidewall 106 and outer wall 110 as desired.

Sidewall 108 extends between base wall 104 and a portion of outer wall 110 which is relatively remote from, sidewall 106. Sidewall 108 includes first and second portions, namely first portion 120 and second portion 122. First portion 120 extends generally perpendicularly from base wall 104 and generally toward outer wall 10. Second portion 122 extends generally angularly between first portion 120 and outer wall 110. Namely, second portion 122 extends at an obtuse angle of about 120 degrees to about 170 degrees, e.g. about 160 degrees, from first portion 120 to the respective lower portion of outer wall 110.

Outer wall 110 extends along length “L” of anchor 68B, generally parallel to, and spaced from, base wall 104. Outer wall 110 is generally defined by three outer wall portions e.g. first planar portion 111A, projection 111B, and second planar portion 111C. The magnitude of the overall width of outer wall 110 is less that the width of base wall 104, as influenced, at least in part, by the particular angle by which second sidewall portion 122 extends from first sidewall portion 120 to top wall 110.

First planar portion 111A and second planar portion 111C extend in a generally coplanar fashion with respect to each other, and are generally separated from each other by projection 111B. Projection 111B extends generally outwardly from the remainder of outer wall 110, away from base wall 104, and is adapted and configured to communicate with, be received by, and housed in, door stop 38 of the jamb member (FIG. 6D). Projection 111B has first and second lateral sidewalls 113 which extend generally perpendicularly away from first and second planar portions 111A, 111C, respectively. Projection 111B further includes an outer projection wall 114 which extends between and generally connects the first and second lateral sidewalls of projection 111B, whereby outer projection wall 114 extends generally parallel to each of the first and second planar portions 111A, 111C of outer wall 110.

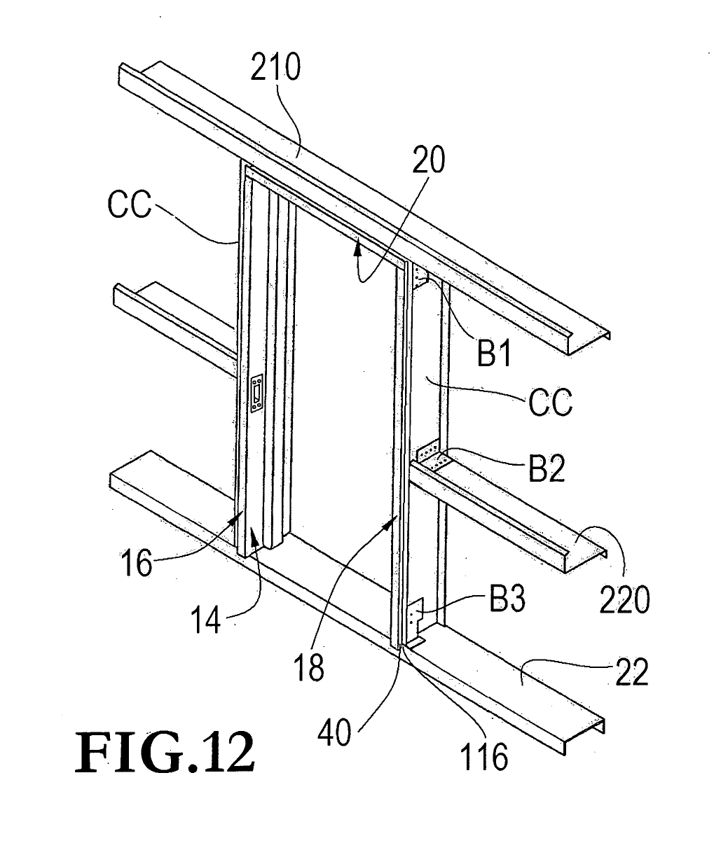

Groove “G” extends into the outer projection wall of projection 111B, and along the length of anchor 68B. Groove “G” enables mounting hardware e.g. temporary draw screws 72 (FIG. 6D), permanent screws 74 (FIGS. 6D, 12), other suitable screws, bolts, nails, and/or other hardware, to self-center and/or otherwise orient and position the hardware, relative to width “BW”. as guided by the hardware deflecting surface characteristics of groove “G.” Although groove “G” is illustrated as a U-shaped depression, groove “G” comprehends a wide variety of profile configurations suitable to at least partially aid in orienting and/or positioning the mounting hardware. Such other suitable profile configurations include, but are not limited to, V-shaped profiles, squared-U-shaped profiles, and/or others.

Referring now to FIG. 7B, since projection 111B extends outwardly beyond first and second planar portions 111A, 111C of outer wall 110, anchor 68B realizes at least first and second distinct height dimensions. A first height dimension corresponds in magnitude to the magnitude of the distance between base wall 104 and first and second planar portions 111A, 111C of outer wall 110, e.g. height BH1. A second block height corresponds in magnitude to the magnitude of the distance between base wall 104 and outer projection wall 114 of projection 111B, e.g. height BH2. Accordingly, anchor 68B generally defines a step change in height as defined by outer wall 110.

Each of webs 112 is a generally elongate member which extends along length “L” of anchor 68B, and extends between base wall 104 and outer wall 110. The surfaces of webs 112 define at least portions of the outer perimeters of elongate cavities 102A, 102B, 102C. Thus, ones of webs 112 operate to separate respective ones of elongate cavities 102A, 102B, 102C from each other. Webs 112 are adapted and configured to provide at least some enhancement of rigidity and/or other structural integrity or strength to anchor 68B.

Anchors 68B are adapted and configured to be e.g. snugly received and/or housed in ones of strike jamb 16, hinge jamb 18 and/or header jamb 20. Accordingly, anchors 68B are adapted and configured to, once received in the jamb member 16, 18, 20, generally resist removal from the jamb member 16, 18, 20 in which the blocks are received, generally by frictional, compressive, and/or resistive forces realized in the engagement between the blocks and the respective jamb members.

Referring now specifically to the exemplary embodiments of FIGS. 6, 6A, 6B, 7A, and 8, spacing blocks 68A are at least as thick as reinforcing plates 67. Accordingly, where plates 67 are 0.19 inch thick, spacing blocks 68A are at least 0.19 inch thick. Typically, blocks 68A are substantially thicker than plates 67, while not being so thick as to occupy a predominant proportion of the thickness of the inner space between rabbet sections 34, 36, and the outer surface of flange ends 40. A convenient thickness for blocks 68A corresponds to the standard thickness of a finish-planed, nominally 1-inch thick piece of lumber, namely ¾ inch thickness. Accordingly, in a hinge jamb assembly designed and configured for use with a building having a nominal 6-inch wall thickness, a typical spacing block 68A has a width “W” of 5½ inches, a length of 4¾ inches, and a thickness of ¾ inch.

In some embodiments, the thickness dimension of spacing blocks 68A corresponds generally closely to the jamb cavity depth, whereby spacing blocks 68A generally fill a major portion of the depth of the cavity of the jamb, such as between distal ends 43 of in-turned flange ends 40, so as to provide a generally planar surface which is adapted and configured to communicate with the a door way rough opening. In such embodiments, the need for insert 70, as part of the assemblage, in addition to spacing blocks 68A is obviated. In other words, the thickness or height dimension of spacing blocks 68A can be generally analogous in magnitude to the magnitude of the thickness or height dimension “BH1” of anchors 68B (FIGS. 6C, 7B).

The invention is, of course, not limited in its application to any one building wall thickness, nor is the invention limited to any one building wall type. Rather, the invention can be employed in a wide variety of building wall thickness and/or with a wide variety of building wall types and configurations, and/or with a wide variety of designs of the metal jamb. Thus, embodiments of the invention are suitable for use with metal e.g. steel-framed, stick-framed e.g. wood framed, or metal stud framed, brick masonry, block masonry, stone masonry, and other building framing concepts. Those skilled in the art are well aware of suitable, for example, hardware and installation methods for respective ones of the various building materials, and wall types and configurations. Such hardware includes, but is not limited to, various screws, bolts, nuts, nails, spin-lock concrete anchors, expanding concrete anchors, and/or others.

Accordingly, ones of the exemplary, non-limiting, illustrated embodiments are particularly well suited for use with certain corresponding ones of various types of building materials and wall types and configurations. As one example, FIGS. 6, 6E, and 8 show cross section views of exemplary embodiments suitable for use with wood framed buildings, and others. As another example, FIG. 6D shows a cross section view of an exemplary embodiment suitable for use with metal e.g. steel-frame buildings, masonry buildings, and others.

Generally, spacing blocks 68A, anchors 68B, and/or other components of the jamb assembly serve as mounting structure which at least partially enables a user to attach e.g. door frame 14 to a building e.g. in a doorway rough opening.

In embodiments in which elongate e.g. wood insert 70 is utilized, such as those illustrated in FIGS. 6 and 8, the function of blocks 68A is to serve as spacers, to provide clearances, spacing, over metal covers, metal reinforcements, in jambs, and to provide additional strength to the metal jamb, wherein the outer surfaces 71 of the blocks are located a common distance, preferably farther away, from rabbet sections 34, 36 than are the corresponding outer surfaces of plates 67. Stated functionally, the outer surfaces 71 of the respective spacing blocks 68A along the length of a jamb define a generally planar mounting surface for receiving reinforcing insert 70. Outer surfaces 71 are contained in a first common plane, and that plane is not generally interrupted by plates 67, or any other structure located between rabbets 34, 36 and a second plane which connects flange ends 40 at their most distal location from jamb face plate 32. While minor interruptions of the first common plane are tolerated, and in some instances are expedient, the area of such interruptions is de minimis compared to the overall area of the plane inside jamb 18. Further, the depth of penetration of any such interruptions, beyond the first common plane, is preferably minor compared to the depth “D” of the jamb between blocks 68A and distal surfaces of flange ends 40.

In embodiments in which spacer blocks 68A are made from a wood based material, the blocks are each typically a cut piece of standard dimension treated lumber, such as ¾ inch thick, nominally 6-inch wide lumber, which fills the width of the jamb space between inner and outer flanges 28, 30. Blocks 68A may be any thickness sufficient to successfully bridge door stop 38, and to provide support against rabbets 34 and 36 while providing an effective level, e.g. planar, mounting surface to receive the reinforcing insert. As illustrated in FIG. 6A, on hinge jamb 18, blocks 68A are preferably placed adjacent the hinge reinforcement plates 67.

Returning to FIGS. 6 and 6A, a single reinforcing wood jamb insert 70 is positioned against spacing blocks 68A, whereby surfaces 71 collectively provide a surface against which insert 70 is mounted. Insert 70 generally fills that portion of inner space 59 which is disposed over spacing blocks 68A and up to those edges of flange ends 40 which are most distal from jamb face plate 32, and between the distal ends 43 of flange ends 40, all as illustrated in FIG. 8. Since the dimensions of wood do change, insert 70 can extend a modest distance beyond flange ends 40 and thus outwardly of space 59, such as up to about ½ inch, preferably no more than about ⅛ inch, beyond flange ends 40. However, it is highly desirable that insert 70 extend at least as far as flange ends 40, whereby, in preferred embodiments, the thickness of insert 70 generally corresponds with dimension “D” (FIG. 6), plus ¼ inch minus zero.

Insert 70 is a wood board, sized specifically to fit, preferably to friction fit tightly, into the allocated space, shown in FIG. 6. Numerous wood boards are suitable for use as insert 70, including, but not limited to, kiln-dried boards, air-dried boards, treated wood boards, and/or other suitable wood boards. Wood insert 70 extends generally the full length of the respective jamb, the full depth “D”, and the width of the jamb between distal ends 43 of the flange ends 40. The outer surfaces of insert 70 are generally planar and continuous along the full length of the insert. Suitable cut-outs can be made in insert 70, e.g. as necessary for the jamb face plate, dust cover and any other hardware which is inserted into the jamb assembly, to facilitate operation of the door and/or jamb. Namely, such cutouts are made to receive any structure, if any, of the respective jamb assembly which extends beyond the common plane which is defined by outer surfaces 71 of the spacing blocks 68A.

In less preferred embodiments, insert 70 can comprise multiple separate and distinct insert segments, each occupying a separate and distinct portion of the length of the jamb, and which cooperatively provide a degree of the functional strength, integrity, and bending and twisting resistance which inheres in insert 70 when the insert is embodied in a single structural element. The greater the dimension of each insert element, relative to the overall length of the particular jamb of interest, e.g. left jamb, right jamb, and the fewer the number of insert elements, resultingly the greater the degree to which the insert elements collectively provide the desired functions of resistance to bending, twisting, and like forces which urge dimensional changes, or movement relative to the building, once the insert is installed in inner space 59 and the jamb assembly is installed in a building.

When multiple jamb inserts are used, adjacent inserts can be spaced from each other thus to receive into such spaces such elements of the jamb assembly which extend beyond the plane defined by outer surfaces 71 of the spacing blocks.

It is also contemplated that insert 70 can be provided as multiple elements which collectively fill the depth “D”, or which collectively span at least the distance between distal ends 43. Such multiple element inserts can be satisfactory so long as they provide the desired reinforcement of the jamb and accommodate attachment to the building such that the jamb assembly does not typically move independent of the building member to which it is attached.

In the configuration illustrated in e.g. FIGS. 6A, 6B, and 8, spacing blocks 68A space the wood jamb insert 70 from any longitudinally intermittent variations of the inner surfaces of rabbets 34, 36 from flat surfaces, and from any other intrusions into space 59 such as by plates 67, which extend from rabbets 34, 36 in a direction generally toward flange ends 40. Blocks 68A also provide solid fill structure to solidly anchor insert 70 against rabbets 34, 36, and thus generally against jamb face plate 32. Spacing blocks 68A also limit the distance between rabbets 34, 36 and wood insert 70, and thereby assist in limiting flexing of inner and outer flanges 28, 30. Flexing can be further limited by using a greater number of spacing blocks 68A, or longer spacing blocks, so long as blocks 68A do not overlie the various jamb structure elements such as hardware associated with the strike or the hinges, so as to fail to provide common surfaces 71 to receive a common plane thereat. However, spacing blocks 68A, or portions of spacing blocks 68A, can overlie such hardware, e.g. plates 67, so long as the blocks are sized and configured to cooperatively accommodate a common mounting surface defined by the plane which extends along surfaces 71. If desired, such overlying blocks 68A need not extend as far as the common, e.g. mounting plane.

As illustrated in FIGS. 6, 6A, 6B, and 8, insert 70 interfaces with jamb 18 at three spatially-displaced points at a given locus along the length of the jamb, namely (i) at the four spacing blocks 68A which are solidly mounted against the jamb face plate, (ii) at the in-turned flange end 40 on inner flange 28 and (iii) at the in-turned flange end 40 on outer flange 30. Given such spaced interfaces, given the forced friction, e.g. wedged, fit, the use of insert 70 results in a substantial stiffening of the jamb assembly, itself.

The jamb assembly is assembled e.g. at a manufacturing facility, and used as follows. Referring to FIGS. 6 and 6A, 6B, an e.g. hinge jamb 18 is laid on a horizontal surface with door stop 38 oriented down, and with the open face of the jamb oriented upwardly. Such jamb has already been fitted with any hardware conventionally associated with the hinges, or the strike or jamb face plate in the case of a strike jamb. Accordingly, in a hinge jamb, hinge reinforcement plates 67 are already permanently mounted in place in the jamb. In the illustrated embodiment, plates 67 are welded to jamb 18.

Blocks 68A are inserted into space 59, against rabbets 34, 36, and adjacent plates 67, as shown in FIG. 6A. Blocks 68A should not overlie plates 67, but can be touchingly-adjacent plates 67. Next, insert 70 is emplaced, friction fit into the remaining void space between flange ends 40, as shown in FIG. 6 and abutted against spacing blocks 68A at surface 71 thus to force at least a modest friction fit of blocks 68A against the inner surface of rabbets 34, 36.

With the blocks 68A and insert 70 temporarily held in place by friction, a plurality of fasteners are driven through insert 70, toward rabbets 34, 36, and into blocks 68A, thus to permanently join blocks 68A and insert 70 to each other, in inner space 59.

Next, the work piece, including jamb 18, blocks 68A, and insert 70, is turned over. Pilot holes are drilled through apertures 73A (FIG. 6B), thence through blocks 68A, and into insert 70 as desired or as necessary. Temporary draw screws 72 are installed through the above-noted apertures 73A, through blocks 68A and into insert 70, and are used to draw insert 70 tight against spacing blocks 68A, and thus to draw spacing blocks 68A tight against jamb face plate 32. Such drawing generally straightens any minor warpage of wood insert 70 against the straight surfaces of rabbets 34, 36 along the length of jamb 18, whereby the structure of jamb 18 serves as a base for straightening any warpage of insert 70. Preferably, draw screws 72 are employed at each spacing block 68A. At the discretion of the user, draw screws 72 can be employed at fewer than all of apertures 73A. However, at least one such draw screw is preferably used in each jamb assembly which embodies spacing blocks 68A and insert 70, thus to securely hold the spacing blocks and insert properly positioned in the jamb assembly until the jamb assembly reaches the job site.

As shown in FIG. 6, temporary draw screw 72 preferably passes through door stop 38, through spacing block 68A, and into insert 70, preferably a screw at each spacing block, thus to provide secure assembly of spacing blocks 68A and insert 70 to the jamb when the door assembly is shipped to the job site. In the alternative, insert 70 can be so dimensioned, and the jamb so configured, that the friction fit between insert 70 and distal ends 43 of flanges 40 of the jamb is sufficient to retain the insert in inner space 59 without any assist of any fasteners. In some embodiments, insert 70 and/or distal ends 43 can be configured to define a cooperative snap-fit between ends 43 and the respective cooperating surfaces of insert 70. In addition, spacing blocks 68A can be so dimensioned as to be held in the cavity defined by inner space 59 only by friction fit between the blocks and inner and outer flanges 28 and 30. In general, though, use of draw screws 72 is preferred.

Apertures 73A are preferably alternately spaced on opposing sides of an imaginary centerline “CL” extending along the length of door stop 38, as illustrated in FIG. 6B.

Referring to FIG. 6, and as an overview, door frame 14 is preferably shipped to the job site completely assembled, including left and right jambs 16, 18, header jamb 20, threshold 22, and door slab 12. In such assembly, left and right jambs 16, 18 have spacing blocks 68A and inserts 70 already mounted therein. Header jamb 20 permissively can have spacing blocks 68A and insert 70, but typically such is not needed.

At the job site, the door assembly is tipped into the rough opening, represented by stud 54 in FIG. 8, without necessity of any further modification of the door assembly. The temporary screws 72 are removed. Longer permanent screws 74, shown in FIG. 8, are screwed into the same apertures 73A in door stop 38, and are advanced into a building member, e.g. a stud 54, framing the doorway opening. Screws 74 thus provide anchors which serve as the anchor structure which anchors the door assembly to the building.

As illustrated in the structure shown in FIGS. 6, 6A, and 8, by filling the space in the jamb inwardly of spacing blocks 68A, e.g. toward flange ends 40, and in combination with the interface provided by the spacing blocks to jamb 16, especially at jamb face plate 32, provides structural rigidity to the resulting jamb assembly. Screws 74 are generally located, along the length of the jamb, so as to attach to, and pass through, blocks 68A thus to provide only a minimal open distance between the jamb, at door stop 38, and a spacing block 68A, at each screw. Since insert 70 is not intended to provide security against terrorist or other war-related incidents, since cost is a substantial consideration, since the bracing of the inserts with respect to jamb face plate 32 and flanges 28 and 30 are substantial elements of the stiffening function of inserts 70, inserts 70 are not made of metal. Rather, inserts are made of lesser cost, lesser density material, whereby the mass of the inserts does not become a substantial concern regarding difficulty of moving, transporting, and the like, as well as cost, with respect to the inserts.

One consideration in selecting the number of blocks 68A which are to be used, in a particular implementation of the invention, is to consider the number of screws 74 which are to be used to anchor the jamb assembly to the building. P Where e.g. relatively longer spacing blocks are used, multiple screws 74 can optionally be used at spaced locations with a given spacing block. Such full-depth and full-width, support of the jamb, from a plane extending across ends 40 to the inner surfaces of rabbets 34, 36, provides substantial resistance to flexing of the jamb, as well as providing structural support to the building at the rough opening. Namely, the securing process, as well as the support of insert 70 and spacing blocks 68A, draws the jamb securely into engagement with the e.g. framing members of the building, whereby the jamb is thus firmly anchored to the building.

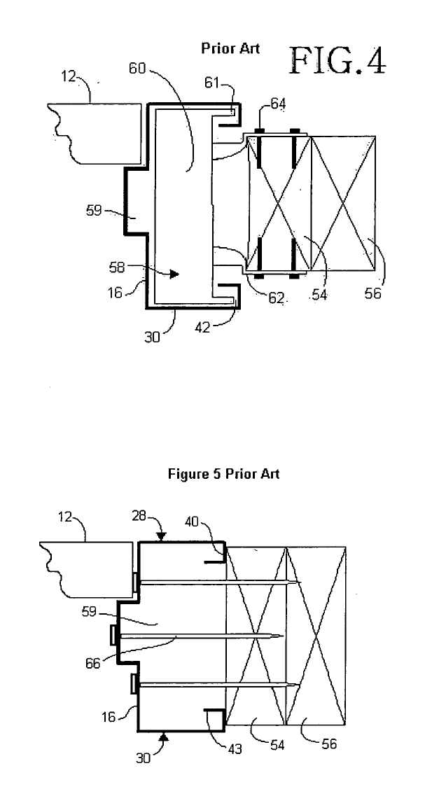

Given the presence of wood insert 70 in the jamb, given the structural support and flex resistance which are provided to the jamb assembly by insert 70, given the structural support and flex resistance which are provided to the building when the jamb assembly is so mounted to the building, the rough opening in the building can be made with a single stud thickness as shown in FIG. 8. Thus, the standard second stud 56 (FIGS. 4 and 5) thickness, which is typically used in framing doorway rough openings, is obviated, and can be omitted. Accordingly, the quantity of lumber, which is normally required to make a doorway rough opening, is typically reduced by half, resulting in savings in cost of framing lumber and cost of framing labor. Thus, not only can framing cost be reduced, the resultant installed door assembly is so stiff and rigid, and is so rigidly mounted to the building, as to move in a unitary manner in common with movements of the building. Namely, the installed door assembly does not move independently of the building.

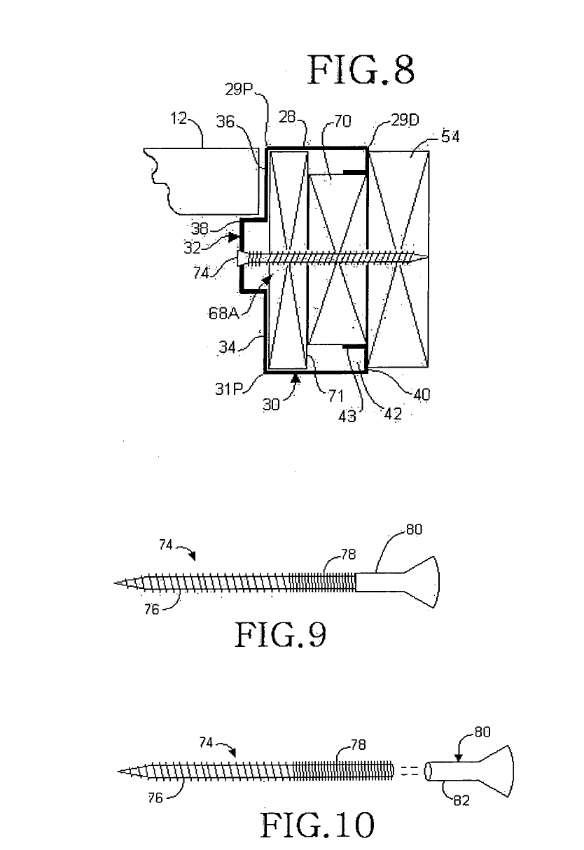

Since the permanent screw 74 remains outwardly of the door slab in an in-swing door installation, a special screw, generally known as a fully threaded hanger bolt, is used as permanent screw 74. As illustrated in FIGS. 9 and 10, the screw body, nominally 5/16 inch diameter, has a first end which bears threads 76 which are suitable for screwing the screw into wood, and a second end which bears conventional machine screw threads 78, e.g. 18 pitch threads. Special screw 74 has a special detachable screw head 80, which has a hollow shaft 82, thus contains a bore. Shaft 82 is threaded on its inner surface, namely in the bore, with the same 18 pitch machine screw threads, to a stop, e.g. a dead end of the bore, at a depth of 11/16 inch in the illustrated embodiment, whereby the bore threadedly receives the threads 78 of the second end of screw 74.

As the door assembly is mounted in the doorway rough opening, once the door assembly is shimmed in a conventional manner, regular clockwise turning force is applied to screws 74 at head 80, whereby screws 74 are advanced through spacing blocks 68A, through insert 70, and into stud 54, and are thus used to mount the jamb elements, namely the jamb 16 or 18, spacing blocks 68A, and insert 70, thus the door frame, to the building studs 54, as discussed above. In such process, the dead end of the bore limits the turning of head 80 with respect to screw body 76 when the screw body reaches the dead end of the bore, and thus forces the screw body to turn with the screw head.

When screw 74 is fully installed, threads 76 are firmly embedded in both insert 70 and stud 54, optionally spacing block 68A as applies, thus securely holding door assembly 10A to the building independent of any location or configuration of head 80, indeed regardless of the presence or absence of head 80. Thus, if during such mounting to the building, a screw 74 is advanced further than it should be, head 80 can be backed off, e.g. turned in the reverse direction which is typically a counter clockwise direction, to the extent needed to correct the depth of head 80, without disturbing the grip of threads 76 in the wood, thus without loosening the grip of threads 76 on either insert 70 or stud 54, optionally spacing block 68A as applies, while maintaining firm engagement with the jamb. Counter clockwise, e.g. loosening turning of head 80 merely turns the head relative to the screw body, whereby the screw body is not withdrawn from spacing block 68A, insert 70, or stud 54.

Thus, if anyone, e.g. an unauthorized person, attempts to remove the screws or otherwise manipulates head 80, thus to remove the door assembly thereby to breach the security provided by the door, only heads 80 are removed, leaving the wood screw portions 76 of the threads still firmly mounting the door frame to the building. Namely, any manipulation of head 80 after the screw body 76 is installed, is ineffective to remove the screw body from stud 54, spacing block, or insert 70. And since the jambs 16, 18, 20, are securely mounted to spacing block 68A and insert 70, neither can the jambs be readily separately removed from the door assembly. The result is improved building security on any swing of door for an e.g. post wood frame building.

While insert 70 has been described as one or more solid pieces of material, e.g. generally without holes, apertures, depressions, voids, cavities, and the like, insert 70 is not, in general so limited. Insert 70 can include such spatial reductions or omissions in material so long as the desired levels of resistance to deformation of the jamb assembly, and desired unity of movement with the building, are obtained in the resultant door assembly.

The hinge jamb assembly corresponding to jamb 18 has been described in some detail above. The strike jamb assembly corresponding to jamb 16 of FIG. 1 is structured in a generally similar manner. The strike jamb assembly starts with a base jamb as at FIG. 2. Any desired reinforcements, such as plates 67, can be optionally installed. The strike hardware is installed. Spacing blocks 68A are then added, followed by insert 70, or multiple inserts or insert elements, as desired, thus to generally add rigidity to the resultant jamb assembly. The resulting strike jamb assembly is then assembled to a respective hinge jamb assembly 18, a header jamb 20, and threshold 22 as desired, to form a resultant door assembly. In general, the header jamb 20 includes only the metal jamb base corresponding to strike jamb 16 or hinge jamb 18, but without the hinge or strike reinforcements. Accordingly, the header jamb typically does not include an insert 70 in the illustrated embodiments. However, an insert 70, and optionally corresponding block or blocks 68A, can be used in the header jamb if and as desired.

Since the primary interfaces between the door assembly and the building members occurs at the left and right jamb assemblies via jambs 16, 18, any attachment of header jamb 20 to the building members is optional and, even if employed, need not be as secure or as rigid as the attachments of the left and right jamb assemblies. Accordingly, use of spacing blocks 68A, insert 70, and screws 74 in header jamb 20 is optional.

In some embodiments, at least one anchor 68B, or a modified version thereof, is, and preferably multiple anchors 68B are, used in lieu of and/or in addition to spacing blocks 68A and elements of insert 70. In such embodiments, anchors 68B generally replace the functions of spacing blocks 68A and insert 70 of FIGS. 6, 6A, 6B, and 8.

Referring now to FIGS. 6C, 6D, 6E, 7B, 7C, 7D, 11, and 12, the function of anchors 68B is generally analogous to that of the combination of blocks 68A and/or reinforcing insert 70. Namely, anchors 68B serve as e.g. hardware receiving anchors to provide a relatively offset C-channel “CC” which enables anchors 68B to receive a metal panel therein. Anchors 68B can optionally serve as spacers, to provide clearances, spacing over metal covers, metal reinforcements in jambs, and to provide additional strength to the metal jamb.

C-channel “CC” includes a C-channel bracket base “CCB” and first and second C-channel bracket legs, e.g. CC1 and CC2. C-channel bracket base “CCB” has an outwardly facing edge and an inwardly facing edge, and a width therebetween. Ones of C-channel bracket legs CC1, CC2 extend generally perpendicularly from respective ones of the outwardly and inwardly facing edges of C-channel bracket base “CCB,” whereby the C-channel appears generally C-shaped as viewed in profile.

C-channel “CC” is relatively offset, relative other components of the jamb assembly. In other words, C-channel “CC” is relatively offset in that anchor 68B and/or the jamb extends outwardly beyond the outermost portion of C-channel “CC,” e.g. C-channel corner leg CC1. Thus, the relatively offset configuration of C-channel “CC,” with respect to other portions of the jamb assembly, enables metal panel 51 to extend beyond C-channel “CC,” namely, beyond C-channel bracket brace “CCB.”

In embodiments in which C-channel “CC” is relatively offset, slot 116 of anchor 68B is generally adjacent the intersection of C-channel corner leg CC1 and C-channel bracket base “CCB.” This position, orientation, adaptation, and/or configuration of slot 116 relative C-channel “CC” enables metal panel 51 to generally planarly extend beyond C-channel bracket base “CCB” and be frictionally, snugly, insertably, and/or otherwise housed in slot 116.

In addition, the outwardly facing surfaces of, for example, the outer walls 110 of the respective spacer anchors 68B interface with respective inwardly facing surfaces of jambs 16, 18, 20. Namely, the outwardly facing surfaces of first and second planar foundation portions 111A, 111C of outer wall 110 communicate with the inwardly facing surfaces of rabbets 34, 36 of the jamb member, respectively. The outwardly facing surfaces of projection 111B communicate with and/or are disposed proximate, respective inwardly facing surfaces of doorstop 38. Accordingly, to the extent of the length “L” of a given anchor 68B, ones of anchors 68B are adapted and configured to generally occupy a major portion of the void defined within the inwardly facing surfaces of ones of the jambs 16, 18, 20, e.g. to the extent of length “L”, ones of anchors 68B are adapted and configured to generally occupy a major portion of space 59.

In the complete assemblage, anchors 68B provide generally rigid fill structure to rigidly anchor and mount the jamb 16, 18, 20, in combination with mounting hardware, into the rough opening and thus against the building in which the door assembly 10B is installed. Also, in providing generally rigid fill structure against rabbets 34, 36, anchors 68B limit the distance that rabbets 34, 36 can flex, whereby rabbets 34, 36 generally resist flexing as compared to jambs which have no fill structure. Correspondingly, the generally rigid fill structure functionality generally limits the flexing of inner and outer flanges 28, 30. Flexing can be further limited by using a greater number of anchors 68B, or longer spacing blocks, so long as anchors 68B do not overlie the various jamb structure elements such as hardware associated with the strike or the hinges.

However, anchors 68B, or portions of anchors 68B, can overlie such hardware, e.g. plates 67, so long as the blocks are sized and configured e.g. modified from the spacing blocks shown, to cooperatively interface with at least some of the inwardly facing surfaces of the jambs 16, 18, 20.

As illustrated in FIG. 6C, the four anchors 68B are solidly mounted against the jamb face plate at a corresponding number of spatially-displaced points at a given locus along the length of the jamb. Further, each anchor 68B communicates with the jamb at multiple locations on the cross-section of the jamb. Referring to FIG. 6D, anchor 68B communicates with the jamb (i) at the distal end 43 of the in-turned flange end 40 on inner flange 28, (ii) at the in-turned flange end at 40 and 43 on outer flange 30, and (iii) at at least one of the inwardly facing surfaces of doorstop 38. Given such spaced interfaces, given the forced friction, e.g. wedged, fit between jamb 16 and anchor 68B, the use of anchors 68B results in a substantial stiffening of the jamb assembly.

In embodiments utilizing anchors 68B, the jamb assembly is assembled, and used, as follows. Referring to FIGS. 6C, 6D, and 6E an e.g. hinge jamb 18 is laid on a horizontal surface with door stop 38 oriented down, and with the open face of the jamb oriented upwardly. Such jamb has already been fitted with any hardware conventionally associated with the hinges, or the strike or jamb face plate in the case of a strike jamb. Accordingly, in a hinge jamb, hinge reinforcement plates 67 are already permanently mounted in place in the jamb. In the illustrated embodiment, plates 67 are welded to jamb 18, although other mounting methods such as riveting, and/or others, are also suitable.

Anchors 68B are inserted into space 59, against rabbets 34, 36, and adjacent plates 67, as shown in FIG. 6C. Anchors 68B should not overlie plates 67, but can be touchingly-adjacent plates 67.

Referring now to FIGS. 7C and 7D, and the process of inserting a anchor 68B into space 59, slot 116 and second portion 122 of block sidewall 108 are collectively sized and configured such that anchor 68B can be mounted into the metal jamb by a rotating insertion step. The slot side of anchor 68B is inserted into the space defined inside the jamb. Slot 116 is hooked under the respective in-turned flange 40 as shown in FIG. 7D, and pivoted about the in-turned flange so as to bring side 106 into firm abutment against the inner surface of outer flange 30 of the jamb.

Correspondingly, the width “BW” of the spacing block is sized to simultaneously bring the first portion 120 into abutting engagement against the inside surface of the distal end 43 of flange 28. The abutments of the sides of the spacing block are shown in FIGS. 6D and 6E. Base 104 is generally flush with the distal surface of in-turned flange end 40, again as seen in FIGS. 6D and 6E. Distal end of flange end 43 can fit quite loosely in slot 116, and indeed need not touch the sides of slot 116, as the spacing block gets its positioning friction from the inside surface of flange 30 and the inwardly-facing surface of distal end 43 of flange 28.

In the alternative, slot 116 can be hooked under the distal edge of flange 28 and side wall 108 wedged against the distal edge 43 of flange 30.

Next, the work piece, including jamb 18 and anchors 68B is turned over. Pilot holes are drilled through apertures 73B, thence through anchors 68B. Temporary draw screws 72 are installed through apertures 73B, and through anchors 68B and are used to draw anchors 68B tight against jamb face plate 32. Preferably, draw screws 72 are employed at each anchor 68B. However, at the discretion of the user, draw screws 72 can be employed at fewer than all of apertures 73B, optionally at none of apertures 73B. However, typically least one such draw screw is preferably used in each anchor 68B, thus to securely hold the respective spacing blocks, by screws as well as by friction, properly positioned in the jamb assembly until the jamb assembly reaches the job site.

As shown in FIGS. 6D and 6E, temporary draw screw 72 preferably passes through door stop 38, and through at least a portion of anchor 68B, preferably a screw at each spacing block, thus to provide a more secure assembly of anchors 68B to the jamb when the door assembly is shipped to the job site. In the alternative, anchors 68B can be so dimensioned, and the jamb so configured, that the combination of the friction fit between the anchors 68B and distal ends 43 of flange ends 40 of the jamb, and the stiffness of the respective jamb 16, 18, is sufficient to retain the blocks in inner space 59 without any assist of any fasteners. In some embodiments, anchors 68B and/or distal ends 43 can be configured to define a cooperative snap-fit between ends 43 and the respective cooperating surfaces of anchors 68B. In addition, anchors 68B can be so dimensioned as to be held in the cavity defined by inner space 59 only by friction fit between the blocks and inner and outer flanges 28 and 30. In general, though, use of draw screws 72 is preferred.

Apertures 73B are preferably alternately spaced on opposing sides of an imaginary centerline “CL” extending along the length of door stop 38, as illustrated in FIG. 6B.

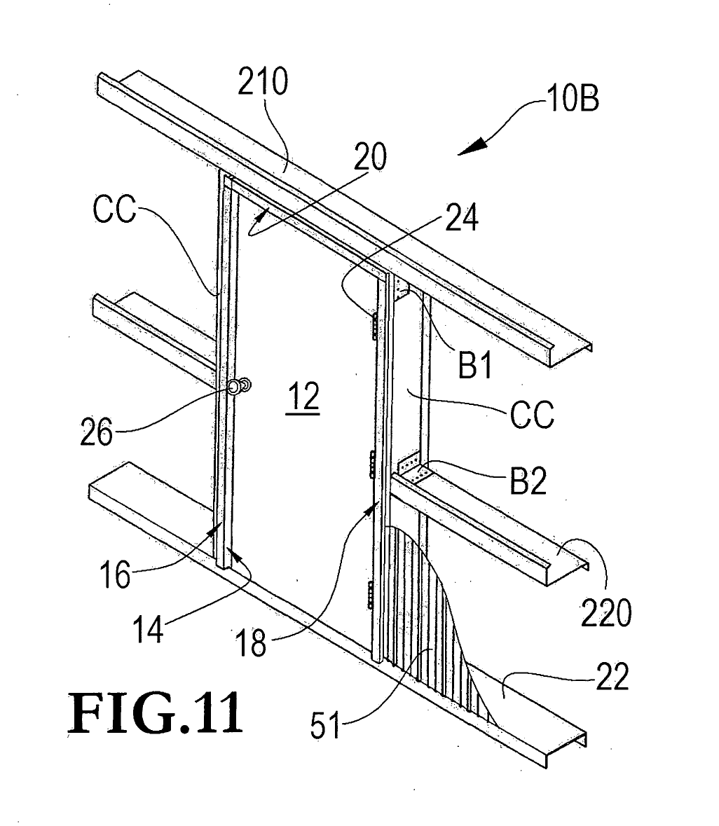

Referring to FIGS. 11, 12, and as an overview, door frame 14 is preferably shipped to the job site completely assembled, including left and right jambs 16, 18, header jamb 20, threshold 22, and door slab 12. In such assembly, left and right jambs 16, 18 have anchors 68B already mounted therein. Header jamb 20 permissively can have anchors 68B, but typically such is not needed.

In buildings which utilize a rough opening defined by a plurality of wood studs, the door assembly is tipped into the rough opening, represented by stud 54 in FIG. 6E, without necessity of any further modification of the door assembly. The temporary screws are removed. Longer permanent screws 74, shown in FIGS. 6C and 12, are screwed into the same apertures 73B in door stop 38, and are advanced into a building member, e.g. a stud, framing the doorway opening. Additional e.g. pilot screw holes can be provided as needed. Screws 74 thus provide anchors which serve as the anchor structure which anchors the door assembly to the building.

In metal frame buildings, e.g. buildings which do not utilize wood studs, such as masonry and/or metal stud buildings, other methods of installing door frame 14 are used. Referring now to FIGS. 11 and 12, in metal frame buildings, metal C-channels “CC” generally define the doorway rough opening, and girts 210, 220 generally provide the framing structures for the outer walls of the buildings. Thus, in a framed in doorway opening in a metal framed building, the jambs and blocks are attached to the C-channels, with drilling of pilot holes as needed, instead of wood studs as in wood framed buildings.

At the jobsite, the C-channels “CC” can be, as one non-limiting example, installed into the building by fastening the C-channels in a generally upright and vertical configuration into the wall structure. Namely, each of the C-channels “CC” are attached to threshold 22, header girt 210, and side girts 220, by header girt bracket B1, side girt bracket B2, threshold bracket B3, and corresponding mounting methods e.g. bolts, nuts, screws, nails, weldments, and/or others. Thus, in the complete assemblage of the door rough opening, ones of C-channels “CC” are generally perpendicular to corresponding ones of threshold 22, header girt 210, and side girts 220.

The door assembly is tipped into the rough opening, represented by C-channel “CC” in FIGS. 6D, 11, 12, without necessity of any further modification of the door assembly. The temporary screws are removed. Longer permanent screws 74, shown in FIG. 6D, are screwed into the same apertures 73B (FIG. 6C) in door stop 38 and anchor 68B, and are advanced into a building member, e.g. the C-channel, framing the doorway opening. Screws 74 thus provide anchors which serve as the anchor structure which anchors the door assembly to the building. As desired, screws 74 can be bolts adapted and configured to threadedly engage corresponding nuts, whereby screws 74 each include a generally flat end, instead of a pointed, tapered, end.

Thus, screws 74 can extend through doorstop 38, through spacing block 38B, and threadedly engage a corresponding aperture which extends through C-channel “CC.” In some embodiments, screws 74 extend through doorstop 38, through spacing block 38B, through C-channel “CC” and in combination with corresponding nuts, clampingly bolt the jamb to the C-channel.

In addition to screws 74, or instead of screws 74, screws “S” attach anchors 68B and the jamb members 16, 18, 20 to e.g. C-channels “CC” and thus to the building. As illustrated in FIG. 6D, one of screws “S” extends through the jamb-facing portion of C-channel “CC” and at least partially into anchor 68B, e.g. at least partially through base wall 104, whereby the screw “S” threadedly engages the block and generally pulls and holds the block and the jamb member against the C-channel “CC” and thus the building.

Also as illustrated in FIG. 6D, a second screw “S” can be assembled to extend through C-channel “CC” and thence through at least one of the in-turned flange ends 40, similar to screws 46 illustrated in FIG. 3. Accordingly, ones of jamb members 16, 18, 20 can be suitably mounted in the rough opening in a variety of ways, and with a variety of suitable hardware. Suitable hardware includes, but is not limited to, screws “S,” screws 46, temporary screws 72, permanent screws 74, long screws, nails, bolts, nuts, and/or other suitable mounting hardware.

As one example, the jamb members and anchors 68B can be mounted in the rough opening by mounting hardware which extends into anchors 68B in a first direction, such as through doorstop 38, and mounting hardware with extends into anchors 68B in a second direction, such as through C-channel “CC.” In some embodiments, mounting hardware extends through only in the first direction, whereby the hardware extends through the doorstop, through the anchors 68B, and through the C-channel “CC,” thereby attaching the door frame to the building.

However, when it is desired to have relatively no mounting hardware on the finished assemblage of door assembly 10B, e.g. at surfaces of the jamb members which face into the doorway opening, the anchors 68B can be transported to the worksite in the jamb members by friction fit alone, and thus without the utilization of, for example, temporary screws 72 to hold the blocks in place. Then, when the door frame is tipped into the rough opening, mounting hardware can be installed through C-channel “CC” into anchors 68B and not though doorstop 38.

As illustrated in the exemplary structure shown in FIGS. 6C and 6D, by generally filling the space 59 (FIG. 2) and in combination with the interface provided by the spacing blocks to jamb 16, anchor 68B, and given a length “L” of at least about 1 inch, typically about 1 inch to 2 inches, a collection of e.g. 3-4 anchors 68B on a standard 80 inch high jamb, provides substantial structural rigidity to the resulting jamb assembly. Screws 74 are generally located, along the length of the jamb, so as to attach to, and pass at least partially through, each of anchors 68B thus to generally pull projections 111B into intimate communication with door stop 38, at each screw.

One consideration in selecting the number of anchors 68B which are to be used, in a particular implementation of the invention, is to consider the number of screws 74 which are to be used to anchor the jamb assembly to the building as well as to consider the level of bending resistance desired in the resulting jamb assembly. Where e.g. relatively longer anchors 68B are used, multiple screws 74 can optionally be used at spaced locations with a given spacing block. Such full-depth support of the jamb, from a plane extending across ends 40 to the inner surfaces of rabbets 34, 36, provides substantial resistance to flexing of the jamb, as well as providing structural support to the building at the rough opening. Namely, the process of securing the jamb to the C-channel “CC”, as well as the lateral support provided by anchors 68B, draws the jamb securely into engagement with the framing members, including but not limited to C-channels “CC” of the building, including increasing the stiffness, rigidity of the jambs, whereby the relatively more rigid, more stiff, jamb is thus firmly anchored to the building.

When a long screw 74 is fully installed, which extends to C-channel “CC”, threads 76 are firmly embedded in anchor 68B and in C-channel “CC”, or a e.g. nut is holding screw 74 mounted to C-channel “CC”, thus securely holding door assembly 10B to the building independent of any location or configuration of head 80, indeed regardless of the presence or absence of head 80. Thus, if during such mounting to the building, a screw 74 is advanced further than it should be, head 80 can be backed off, e.g. turned in the reverse direction which is typically a counter clockwise direction, to the extent needed to correct the depth of head 80, without disturbing the grip of threads 76 in the polymeric material of anchor 68B, thus without loosening the grip of threads 76 on anchor 68B, while maintaining firm engagement with the jamb. Counter clockwise, e.g. loosening turning of head 80 merely turns the head relative to the screw body, whereby the screw body is not withdrawn from anchor 68B the C-channel “CC,” or other framing member.

Again, if anyone, e.g. an unauthorized person, attempts to remove the screws or otherwise manipulates head 80, thus to remove the door assembly thereby to breach the security provided by the door, only heads 80 are removed, leaving the screw portions 76 of the threads undisturbed and, where screw 74 is secured to C-channel “CC”, threads 76 are still firmly mounting the door frame to the building. Namely, any manipulation of head 80 after the screw body is installed, is ineffective to remove the screw body from anchor 68B and/or any framing members. And since the jambs 16, 18, 20, are securely mounted to anchors 68B, neither can the jambs be readily separately removed from the door assembly. The result is improved building security on any door, whether in-swing or out-swing, for an e.g. metal frame building.

The hinge jamb assembly corresponding to jamb 18 has been described in some detail above. The strike jamb assembly corresponding to jamb 16 of FIG. 1 is structured in a generally similar manner. The strike jamb assembly starts with a base jamb as at FIG. 2. Any desired reinforcements, such as plates 67, can be optionally installed. The strike hardware is installed. A desired number of anchors 68B are then added to generally provide the desired level of rigidity to the resultant jamb assembly.

The greater the number of spacing blocks, generally the greater the rigidity of the resulting jamb assembly. The number of spacing blocks needed to achieve a given level of rigidity, depends in part on the thickness and rigidity of the jamb, and in part on the length “L” of the spacing block and in part on the thicknesses of the webs which define walls 104, 106, 108, 110 in the spacing blocks, as well as the thicknesses of the webs 112. In addition, the rigidity is defined in part by the material which is used in making anchors 68B. Typically, where the spacing blocks are about 1 inch in length “L”, the material is high density polyethylene, walls 104, 106, 108, 110, and 112 are about 0.5 inch thick, and where the jamb, itself, is made of e.g. 16 gauge (0.05 inch thick) steel about three to about five spacing blocks are needed to provide typically acceptable rigidity of the jamb assembly.

The resulting strike jamb assembly is then assembled to a respective hinge jamb assembly 18, a header jamb 20, and threshold 22 as desired, to form a resultant door assembly. In general, the header jamb 20 includes only the metal jamb base corresponding to strike jamb 16 or hinge jamb 18, but without the hinge or strike reinforcements. Accordingly, the header jamb typically does not include anchors 68B. However, anchors 68B can be used in the header jamb if and as desired. Further, a temporary threshold may be used in the door assembly where the building frame threshold 22 (FIGS. 11 and 12) is to be used as the operating threshold after the door assembly is installed in the building.

In some embodiments, threshold 22 is not utilized. Rather, in lieu of threshold 22, a concrete or other floor can serve as a threshold surface. As one non-limiting example, a concrete floor, at finished floor height, can lie under the door and/or door assembly.

Non-metallic e.g. polymeric materials suitable for components of door assemblies 10A, 10B e.g. spacing blocks 68A, anchors 68B, insert 70, and others, are various polymeric compounds, such as for example and without limitation, various of the polyolefins, such as a variety of the polyethylenes, e.g. high density polyethylene, or polypropylenes. There can also be mentioned as examples such polymers as polyvinyl chloride and chlorinated polyvinyl chloride copolymers, various of the polyamides, polycarbonates, and others.

For any polymeric material employed in structures of the invention, any conventional additive package can be included such as, for example and without limitation, slip agents, anti-block agents, release agents, anti-oxidants, fillers, and plasticizers, to control e.g. processing of the polymeric material as well as to stabilize and/or otherwise control the properties of the finished processed product, also to control hardness, bending resistance, and the like.

Common industry methods of forming such polymeric compounds will suffice to form non-metallic components of door assemblies 10A, 10B. Exemplary, but not limiting, of such processes are the various commonly known plastics converting processes.

In light of the above description, the exterior appearance of door assemblies of the invention, and jambs used in the invention, are permissively included in the embodiment illustrated in FIGS. 1, 2, and/or others.

The invention, thus, provides substantial benefit, for example and without limitation, in the forms of:
(i) improved door frame rigidity and flex resistance;
(ii) improved securement and improved rigidity of the interface between the door assembly and the building structure/frame, with corresponding greater tendency of the door assembly and the building members to move together in response to forces which are exerted on especially the door assembly;
(iii) reduction in materials and labor required for framing a doorway opening;
(iv) Improved security of attachment of the door assembly to the building for any swing type of door;
(v) novel fasteners which provide improved security against unauthorized tampering with especially an in-swing door assembly;
(vi) easier alignment and shimming of the door in the doorway opening at installation; related to having a full width of the jamb, along the width of insert 70 and/or anchor 68B, for shim contact, anywhere along the length of the insert or block;
(vii) fewer anchors, fasteners needed to install the door; and
(viii) resulting installation time, installation labor, is reduced compared to prior art doors.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

1. A jamb assembly, adapted for use in a door frame, and comprising:
(a) an elongate jamb having a length, and comprising
(i) an inner flange (28) having a first proximal edge, and first inner and first outer surfaces, and a first distal edge,
(ii) an outer flange (30) having a second proximal edge, a second distal edge, and second inner and second outer surfaces, and
(iii) a jamb face plate (32), having third inner and third outer surfaces, and extending between said inner flange at the first proximal edge and said outer flange at the second proximal edge,
an elongate cavity being generally defined in said elongate jamb by the first, second, and third inner surfaces, and extending along the length of said elongate jamb, and extending from a location at or adjacent an inner surface of said jamb face plate to a location at an elongate opening proximate the first and second distal edges of said inner and outer flanges, the elongate opening being defined along the length of said elongate jamb between said inner and outer flanges; and
(b) as a separate and distinct element, at least one anchor (68B), having a length, and being received in the elongate cavity and communicating with said jamb by frictional engagement therewith, thus to enhance at least one of stiffness and rigidity of said jamb assembly.

2. A jamb assembly as in claim 1 wherein said anchor (68B) interfaces either directly or indirectly with said elongate jamb at at least three spatially-displaced points on ones of the first, second, and/or third inner surface of said elongate jamb.

3. A jamb assembly as in claim 1 wherein said anchor (68B) generally occupies a major portion of the cross-sectional area of the elongate cavity corresponding to the length of said anchor.

4. A jamb assembly as in claim 1, said inner and outer flanges having main flange bodies (33) facing each other, in-turned flange ends (40), and distal ends (43) of said in-turned flange ends, said distal ends (43) being spaced from the inner surfaces of said main flange bodies, and wherein a width of said anchor (68B) extends a distance “BW” between said inner and outer flanges, the distance “BW” being greater than a free space width of the elongate opening and less than a distance between the inner surfaces of said main flange bodies of said inner and outer flanges (28, 30).

5. A jamb assembly as in claim 1 wherein said jamb face plate (32) further comprises a door stop (38) extending outwardly from the remainder of said face plate (32) and defining a door stop void therein, said anchor (68B) including an outer wall (110) and a projection (111B) extending outwardly from the remainder of said outer wall, and wherein, within the scope of the length of said anchor, said projection (111B) fills a substantial portion of such door stop void.

6. A jamb assembly as in claim 1, and comprising at least first and second said anchors (68B) disposed in the elongate cavity.

7. A jamb assembly as in claim 6, said anchors (68B) being spaced from each other along the length of said jamb.

8. A jamb assembly as in claim 1, further comprising a draw fastener extending through said jamb plate and into one said anchor (68B), and wherein driving of said draw fastener draws said anchor (68B) toward said jamb face plate.

9. A jamb assembly as in claim 6, further comprising a draw fastener extending through said jamb plate and into said anchor (68B), and wherein driving of said draw fastener draws said anchor (68B) toward said jamb face plate.

10. A jamb assembly as in claim 6, said jamb assembly further comprising, in the elongate cavity, one or more elements of door interface hardware (67) permanently mounted to said jamb, said door interface hardware extending away from said jamb face plate a first distance toward the elongate opening, and further comprising a draw fastener extending through said jamb plate and into said anchor (68B), advancing said draw fastener being effective to draw said anchor (68B) toward said jamb face plate.

11. A jamb assembly as in claim 6 wherein said anchors (68B) extend between said inner flange and said outer flange, and are held in said jamb assembly by frictional engagement with both of said inner flange and said outer flange.

12. A jamb assembly as in claim 6, each said anchor (68B) having a first lateral wall (106), a second lateral wall (108), and a base wall (104) which extends generally between said first and second lateral walls, at least one of said first and second lateral walls having a first wall segment (120) and a second wall segment (122), said first and second wall segments generally intersecting each other and generally defining an obtuse angle therebetween.

13. A jamb assembly as in claim 8, said elongate anchor (68B) including a base wall (104) and an outer wall (110), said outer wall having at least one foundation portion (111A), and a projection (111B) extending outwardly from said foundation portion (111A), the distance between said foundation portion (111A) and said base wall (104) generally defining a first height dimension (BH1), the distance between said projection (111B) and said base wall (104) generally defining a second height dimension (BH2), wherein the magnitude of the second height dimension (BH2) is greater than the magnitude of the first height dimension (BH1).

14. A jamb assembly as in claim 1 wherein said anchor (68B) comprises a polymeric material.

15. A jamb assembly as in claim 1 wherein said at least one anchor (68B) can be mounted in the elongate cavity in combination with a rotating motion of said anchor.

16. A jamb assembly as in claim 1, said anchor (68B) having a first lateral wall (106), a second lateral wall (108), and a base wall (104) which extends generally between said first and second lateral walls, at least one of said lateral walls and said base wall having a slot (116) extending thereinto, said slot (116) extending along the length of said anchor (68B).

17. A jamb assembly as in claim 1, further comprising at least one cavity (102A, 102B, 102C) extending through said anchor, and along the length of said anchor (68B).

18. A jamb assembly as in claim 1, comprising a plurality of said anchors (68B) disposed in the elongate cavity, and spaced at least generally uniformly along the length of the elongate cavity, and imparting substantial incremental increase in rigidity to said jamb in said jamb assembly.

19. A door assembly comprising a hinge jamb assembly, a strike jamb assembly, and a header jamb or header jamb assembly, at least one of said hinge jamb assembly and said strike jamb assembly comprising a jamb assembly as in claim 1.

20. A building comprising a doorway, and a door assembly in said doorway, said door assembly comprising a door assembly as in claim 19.

21. A building as in claim 20, said door assembly being mounted in said doorway using a fastener having a detachable head, thereby securing said jamb to one said anchor (68B), and optionally through said anchor and into a framing member of said building, whereby manipulation of said head is ineffective to remove said fastener from said door assembly.

22. A building doorway, and a door assembly mounted in said doorway, said doorway comprising a rough opening which is defined by building framing members,
said door assembly comprising a plurality of elongate jambs, each having a length, and comprising an inner flange (28) having first inner and first outer surfaces, an outer flange (30) having second inner and second outer surfaces, and a jamb face plate (32) having third inner and third outer surfaces, and an elongate cavity therein extending along the length of said elongate jamb, and defined generally between the first and second inner surfaces of said inner and outer flanges, and extending outwardly of said jamb face plate to an elongate opening into the elongate cavity,
at least one of said elongate jambs further comprising, as a separate and distinct element, at least one anchor (68B), having a length, and being received in the elongate cavity and, within the scope of the length of said anchor, generally occupying a major portion of the elongate cavity, from the third inner surface of said face plate to the flange ends (40),
the doorway rough opening being defined by at least one structural framing member, in facing relationship with said at least one elongate jamb which comprises said anchor (68B).

23. A building comprising a doorway as in claim 22.

24. A building doorway, and a door assembly mounted in said doorway opening as in claim 23 wherein said anchor (68B) interfaces either directly or indirectly with said elongate jamb at at least three spatially-displaced points on ones of the first, second, and third inner surfaces of said elongate jamb.

25. A building doorway, and a door assembly mounted in said doorway opening as in claim 22, said inner and outer flanges on said at least one elongate jamb, having main flange bodies (33) facing each other, in-turned flange ends (40), and distal ends (43) of said in-turned flange ends, said distal ends (43) being spaced from the inner surfaces of said main flange bodies, said inner and outer flanges being connected to each other by said jamb face plate, and wherein a width of said anchor (68B) extends a distance “BW” between said inner and outer flanges, the distance “BW” being greater than a free span width of the elongate opening and less than a distance between the inner surfaces of said main flange bodies of said inner and outer flanges.

26. A building doorway, and a door assembly mounted in said doorway opening as in claim 22, said inner and outer flanges being connected to said jamb face plate, said at least one anchor comprising at least first and second anchors (68B) disposed in the elongate cavity and spaced from each other.

27. A building doorway, and a door assembly mounted in said doorway opening as in claim 22, said inner and outer flanges on said at least one elongate jamb being connected to each other by said jamb face plate, said inner and outer flanges 28, 30 having in-turned flange ends (40), said jamb assembly further comprising, in the elongate cavity, one or more elements of door interface reinforcing hardware (67) permanently mounted to said jamb, said door interface reinforcing hardware having first thicknesses extending away from said jamb face plate and toward the elongate opening, said anchors (68B) collectively providing a mounting surface disposed in a space which extends generally from said door interface hardware outwardly to a locus up to about 0.25 inch beyond the elongate opening.

28. A building doorway and a door assembly mounted in said doorway, as in claim 24, said at least one elongate jamb being secured to said building framing members which define the rough opening by at least one fastener, thereby securing said jamb to one said anchor (68B), and optionally through said anchor and into a framing member of said building, wherein said fastener comprises a threaded fastener body, and as a separate and distinct element, a fastener head, said fastener body and said fastener head being cooperatively configured such that said head can be mounted on said fastener body and thereafter can be used to drive said fastener body into a said anchor, optionally through said jamb assembly and into one of said building framing members which define the rough opening and wherein, after said fastener body has been so driven, said fastener head is ineffective to enable removal of said fastener body from the respective said anchor, or from said building framing member, or from said jamb assembly, whereby manipulation of said fastener head is ineffective for releasing said door assembly from the doorway.

29. A building doorway and a door assembly mounted in said doorway, as in claim 22 wherein said anchor (68B) comprises polymeric material.

30. A building doorway and a door assembly mounted in said doorway, as in claim 23 wherein said at least one anchor (68B) can be mounted in the elongate cavity in combination with a rotating motion of said anchor.

31. A building doorway and a door assembly mounted in said doorway, as in claim 22, said anchor (68B) having a first lateral wall (106), a second lateral wall (108), and a base wall (104) which extends generally between said first and second lateral walls, at least one of said lateral walls and said base wall having a slot (116) extending thereinto, said slot (116) extending along the length of said anchor (68B).

32. A building doorway and a door assembly mounted in said doorway, as in claim 23, further comprising at least one cavity (102A, 102B, 102C) extending through said anchor and along the length of said anchor (68B).

33. A jamb assembly, adapted for use in a door frame, and comprising:
(a) an elongate jamb having a length, and comprising an inner flange (28) having a first main flange body (33) having a first proximal edge and a first distal edge, an outer flange (30) having a second main flange body (33) having a second proximal edge and a second distal edge, and a jamb face plate (32) extending between said inner flange at the first proximal edge and said outer flange at the second proximal edge, said elongate jamb defining an elongate cavity therein extending along the length of said elongate jamb; and
(b) as a separate and distinct element, at least one polymeric anchor (68B), having a length, received in said elongate cavity of said elongate jamb.
